(19) United States
(12) Patent Application Publication
(10) Pub. No.: US 2019/0182286 A1
(43) Pub. Date: Jun. 13, 2019

(54) Identifying communicating network nodes in the presence of Network Address Translation

(71) Applicant: XM Cyber Ltd., Hertzelia (IL)

(72) Inventor: Shahar ZINI, Chatswood (AU)

(21) Appl. No.: 16/033,165

(22) Filed: Jul. 11, 2018

Related U.S. Application Data
(60) Provisional application No. 62/597,287, filed on Dec. 11, 2017.

(51) Int. Cl. H04L 29/06; H04L 29/12; H04L 12/26

(52) U.S. Cl. CPC H04L 63/1433; H04L 63/1416; H04L 61/6063; H04L 61/256; H04L 43/50; H04L 63/1441

(57) ABSTRACT

Methods and systems for executing a penetration test of a networked system by a penetration testing system so as to determine a method by which an attacker to compromise the networked system. The methods and systems include identifying network nodes which can communicate with each other, including overcoming limitations imposed by the use of network address translation protocols.

### CROSS-REFERENCE TO RELATED APPLICATIONS

This patent application claims the benefit of U.S. Provisional Patent Application No. 62/597,287 filed on Dec. 11, 2017, which is incorporated herein by reference in its entirety.

### FIELD OF THE INVENTION

The present invention relates to systems and methods for penetration testing of networked systems to determine security vulnerabilities. In particular, the present invention is suitable for penetration testing of networked systems which employ network address translation.

### BACKGROUND

There is currently a proliferation of organizational networked computing systems. Every type of organization, be it a commercial company, a university, a bank, a government agency or a hospital, heavily relies on one or more networks interconnecting multiple computing nodes. Failures of the networked computing system of an organization or even of only a portion of it might cause a significant damage, up to completely shutting down all operations. Additionally, all data of the organization exists somewhere on its networked computing system, including all confidential data comprising its “crown jewels” such as prices, details of customers, purchase orders, employees' salaries, technical formulas, etc. Loss of such data or leaks of such data to outside unauthorized entities might be disastrous for the organization.

As almost all organizational networks are connected to the Internet at least through one computing node, they are subject to attacks by computer hackers or by hostile adversaries. Quite often the newspapers are reporting incidents in which websites crashed, sensitive data was stolen or service to customers was denied, where the failures were the results of hostile penetration into an organization's networked computing system.

As a result, many organizations invest a lot of efforts and costs in preventive means designed to protect their computing networks against potential threats. There are many defensive products offered in the market claiming to provide protection against one or more known modes of attack, and many organizations arm themselves to the teeth with multiple products of this kind.

However, it is difficult to tell how effective such products really are in achieving their stated goals of blocking hostile attacks, and consequently most CISO's (Computer Information Security Officers) will admit (maybe only off the record), that they don't really know how well they can withstand an attack from a given adversary. The only way to really know how strong and secure a system is, is by trying to attack it as a real adversary would. This is known as red-teaming or penetration testing (pen testing, in short), and is a very common approach that is even required by regulation in some developed countries.

Penetration testing requires highly talented people to man the red team. Those people should be familiar with each and every publicly known vulnerability and attacking method and should also have a very good familiarity with networking techniques and multiple operating systems implementations. Such people are hard to find and therefore many organizations give up establishing their own red teams and resort to hiring external expert consultants for carrying out that role (or completely give up penetration testing).

But external consultants are expensive and therefore are typically called in only for brief periods separated by long intervals in which no such testing is done. This makes the penetration testing ineffective as vulnerabilities caused by new attacks that appear almost daily are discovered only months after becoming serious threats to the organization.

Additionally, even rich organizations that can afford hiring talented experts as in-house red teams do not achieve good protection. Testing for vulnerabilities of a large network containing many types of computers, operating systems, network routers and other devices is both a very complex and a very tedious process. The process is prone to human errors of missing testing for certain threats or misinterpreting the damages of certain attacks. Also, because a process of full testing against all threats is quite long, the organization might again end with a too long discovery period after a new threat appears.

Because of the above difficulties several vendors are proposing automated penetration testing systems. Such systems automatically discover and report vulnerabilities of a networked system, potential damages that might be caused to the networked system, and potential trajectories of attack that may be employed by an attacker.

During the execution of a penetration testing campaign, the penetration testing system frequently needs to find out which other network nodes are accessible from a given network node. Two network nodes are accessible to each other if they can exchange data packets between them. This information is useful for advancing an attack through the tested networked system—after the given network node is compromised by the campaign, there is a good chance that the other nodes that are accessible from the compromised given node can now also be compromised by accessing them from the compromised node, and therefore the penetration testing system should raise the priority of examining those compromising opportunities.

A common way for determining whether two given network nodes are accessible to each other is by determining whether they actually exchange data packets between them during their normal operation. This may be done by installing (before starting the penetration testing campaign) a reconnaissance agent or a packets sniffer on each of the network nodes taking part in the test, and then (during the execution of the penetration testing campaign) monitoring incoming and outgoing data packets in each network node in order to find out which node is communicating with which other node. Additionally, such agents or sniffers can access operating system's management tables, which also contain information useful for determining communication connections.

A naive way of implementing the detecting of communicating nodes is by using the IP addresses appearing in data packets. In most communication protocols all or almost all data packets contain a source address and a destination address, so that the packet may be routed to its intended recipient, and so that the recipient can return an answer to the sender. Also, the operating system maintains a table of active connections, in which one may find the IP address of the remote node of each connection (which information can be retrieved by system utilities, such as “netstat” in Windows).

The local reconnaissance agent or sniffer in a given node can detect the addresses appearing in incoming and outcoming packets, and can also read the connections table of the operating system. This seems to be enough for determining network nodes that are currently communicating with the given node. The detected accessible nodes are then reported by the agent/sniffer to a remote computing device on which the attack function of the penetration testing system is executed, enabling the penetration testing system to determine which node(s) should be targeted next in order to be compromised, relying on the attacker having control of the already compromised node in which the determination of the accessible nodes was done.

Unfortunately, this naive solution does not always work. This has to do with a feature of networks that is called Network Address Translation (NAT for short). In order to understand why was NAT introduced into networks operation, let's consider the following examples.

In a first example, consider a local network within an organization that includes multiple nodes, but only a single node (e.g. a router) that is connected to the outside world (the Internet). Because of lack of IP addresses in the address space of V4 of the Internet Protocol, it is quite common that the local addresses of the nodes within the local network are not global IP addresses and can only be used for communicating within the local network. When a local node (that is not connected to the Internet) wishes to communicate with the external world (e.g. obtain a news item from www.cnn.com), it sends a data packet requesting the news item to the local router, which in turn forwards it to the destination in the outside world (www.cnn.com). The original packet includes a source address that is the local address of the sending node within the local network. The router cannot keep the source address in the forwarded packet as it was in the original packet because it is not a legitimate IP address for the external world. But if the router would put its own Internet address in the forwarded packets as the source address and if two local nodes would access the same Internet service, then when an answer is returned from the outside world to the local router, the router cannot tell which of the two requesting nodes the answer belongs to.

Because of this problem, the router applies NAT to the forwarded packets. The router replaces the source address and port of each original packet that is being forwarded by a fake address and a fake port (the fake address and port shall typically be different for each local node) and remembers the matching between the original local IP address and port of the sending local node and the fake address and port. When the remote server (e.g. www.cnn.com) provides an answer packet, the answer packet will contain the fake address and fake port used in the original request as destination. Using the previously stored translation, the router replaces the fake address and fake port by the corresponding local address and port, and thus knows to which local node the answer should be forwarded.

In a second example, consider an organization having two separate local networks that share a common node (e.g. a router) that has two network connections, one for each network. Such case may typically occur when merging two companies or two departments that previously had independent networks of their own, but may also occur in other circumstances. When a data packet is sent from a node in one network to a node in the other network, it must go through the shared router node. The router receives the packet through one of its two connections, and forwards it through the other connection. Due to shortage of IP addresses, the addresses of nodes in the two networks might overlap. In other words, there might be one or more pairs of nodes, where one node of the pair is in one of the two networks, the other node of the pair is in the other network, and the two nodes share a common IP address. When a data packet is sent from one node of the pair to a destination node in the other network, it goes through the router that forwards it to the other network. If the router would use the address of the sender as the source address of the forwarded packet, then when the destination node sends a response to that address, the response might get to the other node of the pair, as it also has the address specified as destination in the response packet.

Because of this problem, the router applies NAT to the forwarded packets. As in the previous example, the router replaces the source address of each forwarded packet by a fake address (a fake port is not always required, depending on the number of overlapping addresses) and keeps track of the translation. When the destination node in the other network provides an answer packet, the answer packet will contain as destination address the fake address used in the forwarded request which does not correspond to any node in the other network. Using the previously stored translation, the router will replace the fake address by the corresponding original address, and then will use that address for forwarding the answer packet to its correct recipient.

NAT may be used not only for avoiding confusing addresses of responses, but also for balancing processing loads between equivalent remote servers. In a third example, there are multiple remote servers that provide the same services and are intended for reducing processing load and improving response time for clients. A router forwarding a request from a client node addressed to such remote server may detect that a lot of traffic is currently directed to that remote server, and may employ NAT for sending the forwarded packet to an equivalent remote server that is currently not loaded, thus getting the same results with better response time. When the response arrives, the router changes its source address to the address originally requested by the client, so that the client node does not notice the change that had occurred and considers the answer to come from the remote server to which the client had intended to send the request.

See the Wikipedia page for “Network address translation” for additional use cases of NAT.

When NAT is used for packets exchanged between two network nodes, the naive methods that determine whether those two network nodes are accessible to each other by relying on the IP addresses appearing in data packets, do not always produce correct results. The local agent or the packet sniffer on the node that sees only the fake address of the NAT in the packets will conclude the node in which it is installed is communicating with a node having the fake address, which is obviously incorrect Similarly, if the local agent relies on the operating system's connections table for retrieving IP addresses with which the hosting node is communicating, it will falsely conclude the hosting node is communicating with some fake addresses.

There is thus a need to find a way of determining whether two network nodes are communicating with each other and are consequently accessible to each other that produces correct conclusions even when NAT is used along the connection. After a determination is made that a second network node is accessible from a first network mode, a penetration testing system may use that determination for improving its testing—when the first network node is compromised or determined to be compromisable during a penetration testing campaign, attention is given to compromising or evaluating the possibility of compromising the second network node by attacking it from the first network node.

Co-pending U.S. patent applications Ser. Nos. 15/983,309 and 15/911,168, both of which are incorporated herein by reference in their entirety, disclose penetration testing systems and methods for determining methods by which an attacker can compromise a networked system.

Additionally, the following US Patents and Patent Applications disclose implementations of penetration testing systems that may benefit from having a solution to the need described above U.S. Pat. Nos. 6,952,779, 7,757,293, 8,239,951, 8,356,353, 8,490,193, 8,813,235, 2016/0044057 and 2017/0006055. All of these patents and patent applications are incorporated herein by reference in their entirety. Any of the prior art systems, components, methods, and method steps in any of the aforementioned incorporated references may be combined structurally and/or functionally with any of the embodiments disclosed herein so as to create new embodiments of methods and systems or to expand the scope of embodiments.

A penetration testing process involves at least the following main functions: (i) a reconnaissance function, (ii) an attack function, and (ii) a reporting function. The process may also include additional functions, for example a cleanup or recovery function that restores the tested networked system to its original state as it was before the test. In an automated penetration testing system, at least one of the above three functions is at least partially automated, and typically two or three of them are at least partially automated.

A reconnaissance function is the function within a penetration testing system that handles the collection of data about the tested networked system. The collected data may include internal data of networks nodes, data about network traffic within the tested networked system, business intelligence data of the organization owning the tested networked system, etc. The functionality of a reconnaissance function may be implemented by any combination of (i) software executing in a remote computing device, where the remote computing device may probe the tested networked system for the purpose of collecting data about it, (ii) hardware and/or software simulating or duplicating the tested networked system, (iii) a reconnaissance agent software module executing in one or more network nodes of the tested networked system.

An attack function is the function within a penetration testing system that handles the determination of whether security vulnerabilities exist in the tested networked system based on data collected by the reconnaissance function. The functionality of an attack function can be implemented, for example, by software executing in a server that is not one of the nodes of the tested networked system, where the server attempts to attack the tested networked system for the purpose of verifying that it can be compromised.

A reporting function is the function within a penetration testing system that handles the reporting of results of the penetration testing system. The functionality of a reporting function may be implemented, for example, by software executing in the same server that executes the functionality of the attack function, where the server reports the findings of the attack function to an administrator or a CI50 of the tested networked system.

Referring now to the prior art block diagram in FIG. 1, code modules for the reconnaissance function 20, for the attack function 30, for the reporting function 40, and optionally for the cleanup function 50, are each schematically illustrated as part of a penetration testing system code module (PTSCM) 10. The term ‘code’ is intended broadly and may include any combination of computer-executable code and computer-readable data which when read affects the output of execution of the code. The computer-executable code may be provided as any combination of human-readable code (e.g. in a scripting language such as Python), machine language code, assembler code and byte code, or in any form known in the art. Furthermore, the executable code may include any stored data (e.g. structured data) such as configuration files, XML files, and data residing in any type of database (e.g. a relational database, an object-database, etc.).

### SUMMARY

A method for executing a computer-implemented penetration test of a networked system by a penetration testing system so as to determine a method by which an attacker could compromise the networked system, according to embodiments of the present invention, is disclosed. The penetration testing system comprises: (A) a penetration testing software module installed on a remote computing device and (B) a reconnaissance agent software module installed on at least a first network node and a second network node of the networked system. The method for executing the computer-implemented penetration test comprises (a) receiving, by the penetration testing software module and from the first network node, first information about a first data packet sent by the first network node, wherein execution of computer code of the reconnaissance agent software module by one or more processors of the first network node causes the one or more processors of the first network node to send the first information; (b) receiving, by the penetration testing software module and from the second network node, second information about a second data packet received by the second network node, wherein execution of computer code of the reconnaissance agent software module by one or more processors of the second network node causes the one or more processors of the second network node to send the second information; (c) checking, by the penetration testing software module, whether the first information matches the second information; and (d) in response to a determination by the checking that the first information matches the second information, carrying out the following steps: (i) concluding, by the penetration testing software module, that the first data packet and the second data packet are the same data packet and that the first network node is able to send data packets to the second network node, and (ii) determining, by the penetration testing software module, the method by which the attacker could compromise the networked system, wherein the method by which the attacker could compromise includes a step in which the first network node sends a third data packet to the second network node, the third data packet being used for compromising the second network node. The method additionally comprises (e) reporting, by the penetration testing software module, the method by which the attacker could compromise the networked system, wherein the reporting comprises at least one of (i) causing a display device to display a report including information about the determined method by which the attacker could compromise the networked system, (ii) recording the report including the information about the determined method by which the attacker could compromise the networked system in a file, and (iii) electronically transmitting the report including the information about the determined method by which the attacker could compromise the networked system.

In some embodiments, the first data packet and the second data packet can be TCP packets. The first data packet and the second data packet can be SYN-ACK TCP packets. The first data packet and the second data packet can be ACK TCP packets. The first data packet and the second data packet can be SYN TCP packets. The first data packet and the second data packet can both be data packets of a type selected from a group consisting of SYN-ACK TCP packets, ACK TCP packets and SYN TCP packets.

In some embodiments, it can be that (i) the first information includes a first value of a given field of a header of the first data packet, (ii) the second information includes a second value of the given field of a header of the second data packet, and (iii) a necessary condition for the first information to match the second information is that the first value equals the second value. The given field can be a field that is unchanged by network address translation (NAT). It can be that (i) the first data packet and the second data packet are both data packets of a type selected from a group consisting of SYN-ACK TCP packets, ACK TCP packets and SYN TCP packets, and (ii) the given field is a Sequence Number field. It can be that (i) the first data packet and the second data packet are both data packets of a type selected from a group consisting of SYN-ACK TCP packets, ACK TCP packets and SYN TCP packets, and (ii) the given field is an Acknowledgement Number field.

In some embodiments, it can be that (i) the first information includes respective first values of multiple given fields of a header of the first data packet, (ii) the second information includes respective second values of the multiple given fields of a header of the second data packet, and (iii) a necessary condition for the first information to match the second information is that for each specific field of the multiple given fields, the respective first value equals the respective second value. It can be that (i) the first data packet and the second data packet are both data packets of a type selected from a group consisting of SYN-ACK TCP packets, ACK TCP packets and SYN TCP packets, and (ii) the multiple given fields include a Sequence Number field and an Acknowledgement Number field. The multiple given fields can include at least three fields.

In some embodiments, it can be that (i) the first information includes a first result of a first computation based on values of one or more given fields of a header of the first data packet, (ii) the second information includes a second result of a second computation based on values of the one or more given fields of a header of the second data packet, and (iii) a necessary condition for the first information to match the second information is that the first result equals the second result. The first computation and the second computation can both be computations of a hash function. The first computation and the second computation can both be computations of a XOR function. It can be that (i) the first data packet and the second data packet are both data packets of a type selected from a group consisting of SYN-ACK TCP packets, ACK TCP packets and SYN TCP packets, and (ii) the one or more given fields include a Sequence Number field and an Acknowledgement Number field. The one or more given fields can include at least three fields.

In some embodiments, a necessary condition for the first information to match the second information can be that the absolute value of the difference in time between the receiving of the first information and the receiving of the second information is lower than a given threshold.

In some embodiments, a necessary condition for the first information to match the second information can be that the absolute value of the difference between a first time stamp included in the first information and a second time stamp included in the second information is lower than a given threshold.

In some embodiments, it can be that (i) the first information includes a first indication that indicates that the first data packet is sent by the first network node, and (ii) the second information includes a second indication that indicates that the second data packet is received by the second network node.

In some embodiments, the method can further comprise (f) while the executing of the penetration test is ongoing, receiving, from the first network node, third information about a fourth data packet sent by the first network node; (g) while the executing of the penetration test is ongoing, receiving, from the second network node, fourth information about a fifth data packet received by the second network node; and (h) further checking, by the penetration testing software module, whether the third information matches the fourth information, wherein the concluding and the determining are carried out in response to occurrence of both (i) the determination by the checking that the first information matches the second information and (ii) a determination by the further checking that the third information matches the fourth information.

A system for executing a computer-implemented penetration test of a networked system so as to determine a method by which an attacker could compromise the networked system, according to embodiments of the present invention, is disclosed herein. The networked system comprises a plurality of network nodes interconnected by one or more networks. The system for executing the computer-implemented penetration test comprises: (a) a first reconnaissance-agent non-transitory computer-readable storage medium for storage of instructions for execution by one or more processors of a first network node, the first network node being in electronic communication with a remote computing device, the first reconnaissance-agent non-transitory computer-readable storage medium having stored therein first instructions, that when executed by the one or more processors of the first network node, cause the one or more processors of the first network node to send, to the remote computing device, information about a data packet sent by the first network node or received by the first network node; (b) a second reconnaissance-agent non-transitory computer-readable storage medium for storage of instructions for execution by one or more processors of a second network node, the second network node being in electronic communication with the remote computing device, the second reconnaissance-agent non-transitory computer-readable storage medium having stored therein second instructions, that when executed by the one or more processors of the second network node, cause the one or more processors of the second network node to send, to the remote computing device, information about a data packet sent by the second network node or received by the second network node; (c) a penetration-testing non-transitory computer-readable storage medium for storage of instructions for execution by one or more processors of the remote computing device, the penetration-testing non-transitory computer-readable storage medium having stored therein: (i) third instructions, that when executed by the one or more processors of the remote computing device, cause the one or more processors of the remote computing device to receive, from the first network node, first information about a first data packet sent by the first network node, (ii) fourth instructions, that when executed by the one or more processors of the remote computing device, cause the one or more processors of the remote computing device to receive, from the second network node, second information about a second data packet received by the second network node, (iii) fifth instructions, that when executed by the one or more processors of the remote computing device, cause the one or more processors of the remote computing device to check whether the first information matches the second information, (iv) sixth instructions, that when executed by the one or more processors of the remote computing device, cause the one or more processors of the remote computing device to carry out the following steps in response to a determination made by executing the fifth instructions that the first information matches the second information: (A) concluding that the first data packet and the second data packet are the same data packet and that the first network node is able to send data packets to the second network node, and (B) determining the method by which the attacker could compromise the networked system, wherein the determined method by which the attacker could compromise includes a step in which the first network node sends a third data packet to the second network node, the third data packet being used for compromising the second network node, and (v) seventh instructions, that when executed by the one or more processors of the remote computing device, cause the one or more processors of the remote computing device to report the determined method by which the attacker could compromise the networked system, wherein the reporting comprises at least one of (i) causing a display device to display a report including information about the determined method by which the attacker could compromise the networked system, (ii) recording the report including the information about the determined method by which the attacker could compromise the networked system in a file, and (iii) electronically transmitting the report including the information about the determined method by which the attacker could compromise the networked system.

In some embodiments, the first data packet and the second data packet can be TCP packets. The first data packet and the second data packet can be SYN-ACK TCP packets. The first data packet and the second data packet can be ACK TCP packets. The first data packet and the second data packet can be SYN TCP packets. The first data packet and the second data packet can both be data packets of a type selected from a group consisting of SYN-ACK TCP packets, ACK TCP packets and SYN TCP packets.

In some embodiments, it can be that (i) the first information includes a first value of a given field of a header of the first data packet, (ii) the second information includes a second value of the given field of a header of the second data packet, and (iii) a necessary condition for the first information to match the second information is that the first value equals the second value. The given field can be a field that is unchanged by network address translation (NAT). It can be that (i) the first data packet and the second data packet are both data packets of a type selected from a group consisting of SYN-ACK TCP packets, ACK TCP packets and SYN TCP packets, and (ii) the given field is a Sequence Number field. It can be that (i) the first data packet and the second data packet are both data packets of a type selected from a group consisting of SYN-ACK TCP packets, ACK TCP packets and SYN TCP packets, and (ii) the given field is an Acknowledgement Number field.

In some embodiments, it can be that (i) the first information includes respective first values of multiple given fields of a header of the first data packet, (ii) the second information includes respective second values of the multiple given fields of a header of the second data packet, and (iii) a necessary condition for the first information to match the second information is that for each specific field of the multiple given fields, the respective first value equals the respective second value. It can be that (i) the first data packet and the second data packet are both data packets of a type selected from a group consisting of SYN-ACK TCP packets, ACK TCP packets and SYN TCP packets, and (ii) the multiple given fields include a Sequence Number field and an Acknowledgement Number field. The multiple given fields can include at least three fields.

In some embodiments, it can be that (i) the first information includes a first result of a first computation based on values of one or more given fields of a header of the first data packet, (ii) the second information includes a second result of a second computation based on values of the one or more given fields of a header of the second data packet, and (iii) a necessary condition for the first information to match the second information is that the first result equals the second result. The first computation and the second computation can both be computations of a hash function. The first computation and the second computation can both be computations of a XOR function. It can be that (i) the first data packet and the second data packet are both data packets of a type selected from a group consisting of SYN-ACK TCP packets, ACK TCP packets and SYN TCP packets, and (ii) the one or more given fields include a Sequence Number field and an Acknowledgement Number field. The one or more given fields can include at least three fields.

In some embodiments, a necessary condition for the first information to match the second information can be that the absolute value of the difference in time between the receiving of the first information and the receiving of the second information is lower than a given threshold.

In some embodiments, a necessary condition for the first information to match the second information can be that the absolute value of the difference between a first time stamp included in the first information and a second time stamp included in the second information is lower than a given threshold.

In some embodiments, it can be that (i) the first information includes a first indication that indicates that the first data packet is sent by the first network node, and (ii) the second information includes a second indication that indicates that the second data packet is received by the second network node.

In some embodiments, it can be that (i) the third instructions, when executed by the one or more processors of the remote computing device, further cause the one or more processors of the remote computing device to receive, from the first network node and while the executing of the penetration test is ongoing, third information about a fourth data packet sent by the first network node, (ii) the fourth instructions, when executed by the one or more processors of the remote computing device, further cause the one or more processors of the remote computing device to receive, from the second network node and while the executing of the penetration test is ongoing, fourth information about a fifth data packet received by the second network node, (iii) the fifth instructions, when executed by the one or more processors of the remote computing device, further cause the one or more processors of the remote computing device to check whether the third information matches the fourth information, and (iv) the concluding and the determining carried out by executing the sixth instructions by the one or more processors of the remote computing device, are carried out in response to occurrence of both (A) the determination made by executing the fifth instructions that the first information matches the second information and (B) a determination made by executing the fifth instructions that the third information matches the fourth information.

### BRIEF DESCRIPTION OF THE DRAWINGS

FIG. 1 shows a block diagram of a prior-art penetration testing system code module.

FIG. 2 shows a schematic illustration of a networked system comprising multiple network nodes, some of which have a reconnaissance agent software module installed therein, and a remote computing device in the cloud, having a penetration testing software module installed therein and in connection with the networked system, according to embodiments.

FIG. 3 shows a schematic illustration of a networked system comprising multiple network nodes, some of which have a reconnaissance agent software module installed therein, and a remote computing device located locally, having a penetration testing software module installed therein and in connection with the networked system, according to embodiments.

FIGS. 4 and 5 show respective flowcharts of methods for executing a computer-implemented penetration test of a networked system by a penetration testing system so as to determine a method by which an attacker could compromise the networked system, according to embodiments.

FIG. 6A shows a block diagram of a networked system having first and second network nodes each of which has a reconnaissance agent software module installed therein, and a remote computing device having a penetration testing software module installed therein and in connection with the networked system, according to embodiments.

FIGS. 6B and 6C are, respectively, block diagrams of first and second non-transitory computer-readable storage media installed at the first and second network nodes of FIG. 6A, comprising respective groups of program instructions.

FIG. 6D shows a block diagram of a non-transitory computer-readable storage medium installed at the remote computing device of FIG. 6A, comprising groups of program instructions.

FIG. 6E shows a block diagram showing a detail of one of the groups of program instructions of FIG. 6D.

FIG. 7A shows a block diagram of a non-transitory computer-readable storage medium installed at the remote computing device of FIG. 6A, comprising groups of program instructions, according to an alternative embodiment.

FIG. 7B shows a block diagram showing a detail of one of the groups of program instructions of FIG. 7A.

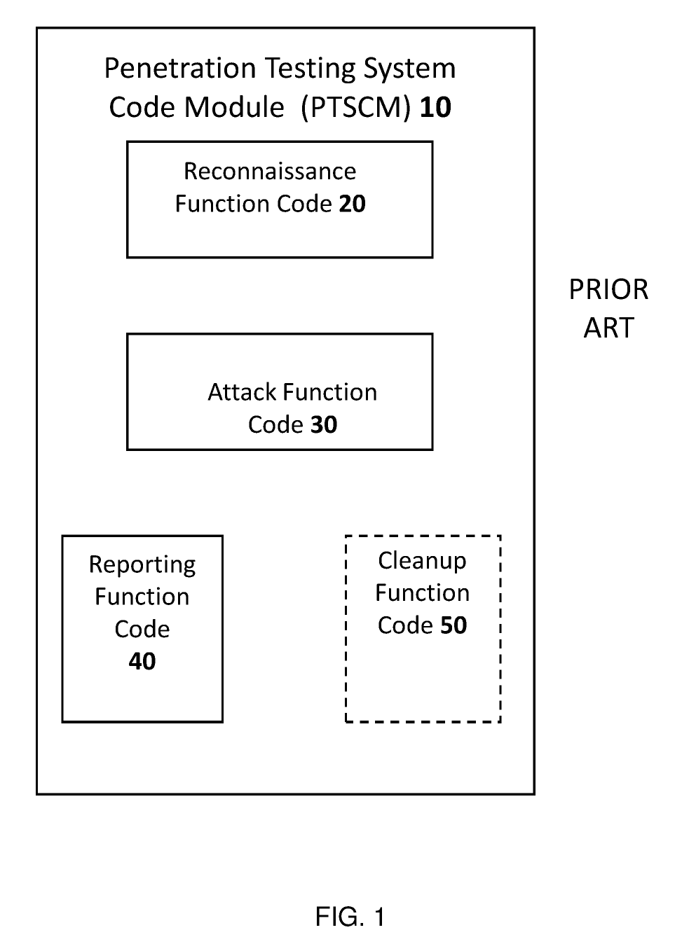

### DETAILED DESCRIPTION OF THE EMBODIMENTS

Note: Throughout this disclosure, subscripted reference numbers (e.g., 101) or letter-modified reference numbers (e.g., 100a) may be used to designate multiple separate appearances of elements in a single drawing, e.g. 10₁ is a single appearance (out of a plurality of appearances) of element 10, and likewise 100a is a single appearance (out of a plurality of appearances) of element 100.

It can be advantageous to determine the existence of communication between network nodes without being dependent on the correctness of the IP addresses appearing in packets or in connection tables, thus reducing or eliminating sensitivity to incorrect addresses generated by NAT. Instead, according to embodiments, communicating network nodes can be identified based on one or more other information fields appearing in data packets, as will be elaborated below.

It should be noted that according to the embodiments disclosed herein, the existence of communication between two nodes is not determined locally by the agents/sniffers running in those nodes. Instead, the local agents/sniffers running on those nodes collect certain information from incoming and outgoing packets (as will be explained below) and report that information to the remote computing device on which the attack function of the penetration testing system is executed. The remote computing device analyzes the information received from both nodes and by matching it between the two nodes (as will be explained below), determines whether there is currently communication between them.

Note that the remote computing device knows which node is the source of each report, even if NAT is employed for the communication between a reporting agent/sniffer and the remote computing device. This is because a reporting agent identifies itself by an identification number, and the remote computing device knows which agent identification number is associated with each node of the tested networked system. Alternatively, the reporting agent may uniquely identify the node hosting it by including in its report a number uniquely associated with its hosting node, such as CPU serial number, network card serial number, etc.

As an example, let us consider the Transmission Control Protocol (TCP) communication protocol, which is the most common protocol for Internet communication. Headers of packets of the TCP protocol contain two fields called “Sequence Number” and “Acknowledgement Number”. The Wikipedia page for “Transmission Control Protocol” provides the following explanation for the use of these two fields:

Connection Establishment

To establish a connection, TCP uses a three-way handshake. Before a client attempts to connect with a server, the server must first bind to and listen at a port to open it up for connections: this is called a passive open. Once the passive open is established, a client may initiate an active open. To establish a connection, the three-way (or 3-step) handshake occurs:

SYN: The active open is performed by the client sending a SYN to the server. The client sets the segment's sequence number to a random value A.

SYN-ACK: In response, the server replies with a SYN-ACK. The acknowledgment number is set to one more than the received sequence number i.e. A+1, and the sequence number that the server chooses for the packet is another random number, B.

ACK: Finally, the client sends an ACK back to the server. The sequence number is set to the received acknowledgement value i.e. A+1, and the acknowledgement number is set to one more than the received sequence number i.e. B+1.

At this point, both the client and server have received an acknowledgment of the connection. The steps 1, 2 establish the connection parameter (sequence number) for one direction and it is acknowledged. The steps 2, 3 establish the connection parameter (sequence number) for the other direction and it is acknowledged. With these, a full-duplex communication is established.

An advantage of using the above types of packets for determining connectivity is that those packet types are used only once per connection, and therefore do not generate heavy processing by the client/sniffer and by the remote computing device (as would be the case if we would base the determination of connectivity on regular data packets that are numerous).

In a particular straightforward embodiment, an agent/sniffer in each node locates only SYN-ACK packets (and ignores all other packet types). Both incoming and outgoing SYN-ACK packets are identified. Identifying a packet to be of the SYN-ACK type is straightforward—the TCP header includes a SYN flag and an ACK flag, and any packet having these two flags turned on is a SYN-ACK packet.

An agent/sniffer that detects a SYN-ACK packet (regardless if incoming or outgoing) sends the Sequence Number included in the packet to the remote computing device on which the attack function of the penetration testing system is executed. The remote computing device collects such reports from the nodes of the tested networked system, and attempts to find a match between Sequence Numbers received from different nodes. If a match is found between reported numbers received from two nodes, it may be assumed with a very high probability that both reports apply to the same SYN-ACK packet, one reported by the sending node and the other reported by the receiving node. Therefore, it can be concluded that two nodes whose reported Sequence Numbers matched are currently communicating with each other.

In another embodiment, the Acknowledgement Number in the header of the SYN-ACK packets is used as the field to be matched. This embodiment is almost identical to the previous one, except that the Acknowledgement Number is used instead of the Sequence Number.

In another embodiment, both the Sequence Number and the Acknowledgement Number of the SYN-ACK packets are used for the matching of the SYN-ACK packets. In this case both numbers are reported to the remote computing device by a client/sniffer identifying a SYN-ACK packet, and a match is declared only if both numbers match.

In another embodiment, both the Sequence Number and the Acknowledgement Number of the SYN-ACK packets are used for the matching of the SYN-ACK packets (as in the previous embodiment), but sending both numbers to the remote computing device is avoided. Instead, a hash function of both numbers is sent, thus reducing the amount of data that has to be reported. For example, a XOR function may be applied to the two numbers, and only the result of the XOR operation is reported and matched.

In another embodiment, not only the Sequence Number and the Acknowledgement Number of the SYN-ACK packets are used for the matching, but also one or more other additional fields that appear in the header of the SYN-ACK packets. Only fields that are not changed by NAT may be used. Therefore, the Source Address, Destination Address, Source Port and Destination Port fields may not be used for that purpose. For example, the “Window Size” field may be used in the matching, requiring this field to also be reported to the remote computing device, and also requiring a match between the Window Size of the two reports (on top of matching the Sequence Numbers and the Acknowledgement Numbers) in order to declare a match of the two SYN-ACK packets.

In another embodiment, one or more other fields are used in the matching (as in the previous implementation), but the reporting to the remote computing device includes only a hash of the fields used for the matching. For example, each client/sniffer may send out only the result of hashing the Sequence Number, the Acknowledgement Number and the Window Size of an identified SYN-ACK packet.

In another embodiment, ACK packets are used instead of SYN-ACK packets. Identifying a packet to be of the ACK type is straightforward—any packet having its ACK flag turned on and its SYN flag turned off is an ACK packet. All the embodiments described above for the SYN-ACK case are equally relevant for the ACK case, with the required adjustments. Using ACK packets instead of SYN-ACK packets has an advantage of detecting the connection at a later step, thus avoiding matching packets of connections that fail between the SYN-ACK and the ACK steps.

In another embodiment, SYN packets are used instead of SYN-ACK packets. Identifying a packet to be of the SYN type is straight-forward—any packet having its SYN flag turned on and its ACK flag turned off is a SYN packet. Some of the implementations described above for the SYN-ACK case are equally relevant for the SYN case, with the required adjustments. Using SYN packets instead of SYN-ACK packets has a disadvantage of not being able to use the Acknowledgement Number for the matching. Additionally, it has a disadvantage of detecting the connection at an earlier step, thus matching packets of connections that might later fail between the SYN and the ACK steps.

In another embodiment, more than one type of packets are used for the matching. For example, both SYN-ACK and ACK packets have to match in order for the remote computing device to declare the two nodes to be in communication. Alternatively, either SYN-ACK or ACK packets have to match in order for the remote computing device to declare the two nodes to be in communication

In other embodiments, the client/sniffer may also (in addition to implementing the methods described above) operate as in the naive solutions described above and report connections it locally detects based on IP addresses, even though they cannot be trusted due to the NAT issue. Such reports may be useful for saving processing in the remote computing device—matching packets in a large network containing many nodes may be an intensive task, and alerts regarding potential connections received from agents/sniffers (even if not fully reliable because of NAT) may direct the remote computing device's attention to potential pairs of nodes whose matching of packets should be given a higher priority. Thus, even though the locally-detected connections cannot be trusted for reaching reliable conclusions regarding accessible nodes, they can still improve the efficiency of reaching reliable conclusions by the methods of the present invention.

In other embodiments, operating according to the naive solution in addition to implementing any of the methods described above may be for backup purposes. It might be the case that some of the local agents/sniffers installed on some network nodes cannot sniff the packets because of restrictions imposed by the local environment of the nodes. In such case the agent/sniffer is not able to determine Sequence Numbers and Acknowledgement Numbers, and the above methods are not applicable for those nodes. The use of the naive solution in combination with the other disclosed embodiments provides a fallback for determining connectivity of those nodes, even though the fallback determinations are not as reliable as the determinations of the newly proposed methods due to the NAT issues.

When implementing the naive solution in addition to implementing the other disclosed embodiments, an agent/sniffer may report its naive connectivity findings to the remote computing device the same way it is done in the prior art (i.e. the agent/sniffer reports conclusions about which nodes are communicating with its hosting node, based on IP addresses and/or OS connection tables). Alternatively, the agent/sniffer may take advantage of the fact that it is already reporting some fields of the packets (e.g. Sequence Number) and add addressing fields (source/destination IP address and port) to those reports, leaving it for the remote computing device to make the connectivity determinations. This alternative may simplify the implementation in the remote computing device, as only one type of messages has to be dealt with.

For all the above embodiments, the matching of packets may additionally require that the packets are reported at approximately the same time. In other words, two packets can be considered to be matching only if the difference in time between their reporting is lower than a given threshold. In one non-limiting example, two packets that are received by the remote computing device with a time difference of more than 10 seconds, cannot be matched. In other examples, packets that are received by the remote computing device with a time difference of more than 5 seconds, or more than two seconds, or more than one second, cannot be matched.

Alternatively or additionally, a centrally-synchronized time-stamped mechanism may be used, in which all agents are synchronized to a common time base with the remote computing device. The common time base does not have to be related to the true time, as long as all agents are synced to the same time base. When reporting a packet, an agent includes in the report a timestamp based on the time of detecting the packet. The remote computing device matches packets in time based on the reported timestamps rather than based on time of arrival of the reports to the remote computing device. This way it is possible to have a time-based embodiment in which the time of reporting by an agent does not affect the connectivity conclusions.

Also, for all the above embodiments, the matching of packets reported by two network nodes may additionally require that one of the two packets is being sent out of one of the two network nodes, while the other packet is being received by the other network node. In other words, if the two reported packets are indeed the same packet, then one reporting node must be a sender of the packet while the other node must be a receiver of the packet. In order to implement this logic, the reporting of the agent/sniffer to the remote computing device about a detected packet should include a Boolean indicator (i.e. a flag) that indicates whether the currently reported packet was sent by the reporting node or received by the reporting node.

The above explanations disclose a method of determining connectivity between network nodes in a networked system and reaching correct conclusions even when NAT is used along the connection. This method is in turn used for conducting reliable penetration testing of a networked system. However, this method of determining connectivity in the presence of NAT may also be useful for other applications.

For example, the above method of determining connectivity may be used for learning the structure of a networked system and generating a map of its architecture. This may be used in various types of network testing equipment, for example, test equipment that monitors and analyzes network traffic workload and test equipment that determines network traffic bottlenecks and recommends solutions.

Any use of the above disclosed method of determining connectivity between nodes of a networked system is included within the scope of the present invention.

In some embodiments, a reconnaissance agent software module (“RASM”) is installed in one or more network nodes of a tested networked system. Installed in a network node, the reconnaissance agent collects information about data packets sent by the node or received by the node, and sends the information to a remote computing device where a penetration testing software module (PTSM) is installed.

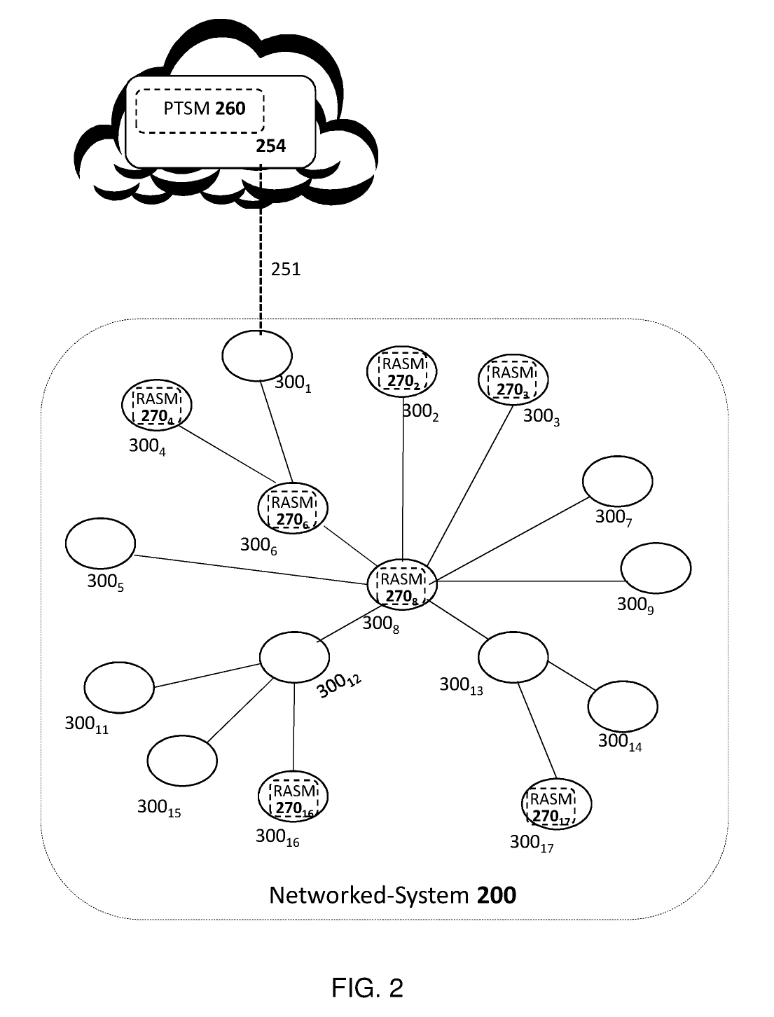

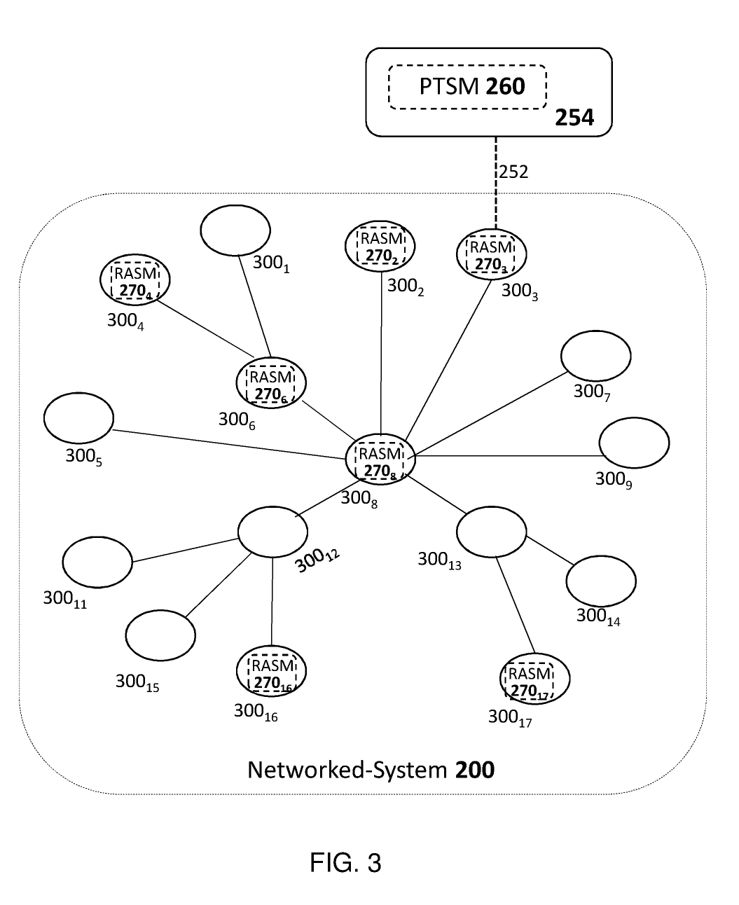

Referring now to the figures and in particular to FIGS. 2 and 3, examples of a penetration testing system are illustrated schematically in accordance with embodiments of the invention. The penetration testing system comprises a penetration testing software module (PTSM) 260 installed on a remote computing device 254 and a reconnaissance agent software module (RASM) 270 installed on at least some of a plurality of network nodes 300 of a networked system 200.

The number of network nodes 300 can be as few as two and as many as several hundred or several thousand. They can be connected hierarchically, peer-to-peer, hub-and-spoke, or in any combination of connections as long as each networked node 300 is connected to at least one other node 300.

In the example of FIG. 2, the remote computing device 254 on which the PTSM 260 is installed is external to the networked system 200 and is in communication with the networked system 200 by an Internet connection 251. In this case, the physical location of remote computing device 254 is unimportant. It can be, by way of non-limiting examples, at a physical location belonging to a supplier or operator of a penetration testing system, in a ‘cloud’ server farm of an Internet services or cloud services provider, or it can be physically co-located with some or all of the network nodes 300. FIG. 3 illustrates a similar networked system 200 with a plurality of network nodes 300, where the PTSM 260 is installed in a remote computing device 254 which is in communication with the networked system 200 via a local-area network (LAN) connection 252. In other cases, the remote computing device on which the PTSM is installed may be internal to the networked system 200. For example, the PTSM may be executed by a virtual machine residing in one of the network nodes 300.

As will be discussed below, in embodiments of the invention, PTSM 260 and at least two implementations of RASM 270 in two respective network nodes 300 cooperate to collectively subject the networked system 200 to penetration testing that identifies communicating network nodes in order to determine methods by which the networked system 200 can be compromised.

An attacker could compromise a networked system by (i) compromising a first node 300_{X} and then (ii) causing the sending of a malicious data packet from compromised first node 300_{X} to second node 300_{Y}, where nodes 300_{X} and 300_{Y} are in communication with each other, and where the malicious data packet causes second node 300_{Y} to become compromised. This gradual approach to compromising node 300_{Y} can succeed even when a direct attack from outside networked system 200 on node 300_{Y} cannot succeed because of defensive measures existing in node 300_{Y}. Because the gradual approach submits the attack on node 300_{Y} from a legitimate node of networked system 200 (i.e. from node 300_{X}), the defensive measures of node 300_{Y} might treat the malicious data packet with a higher level of trust than data packets received from external sources, and consequently might fail in identifying it as a malicious attack and in defending against it.

Compromising the first node 300_{X} can be accomplished in any number of ways as is known in the art. For example, if node 300_{X} is identified as a node operating as a Windows® workstation that runs a specific version of the operating system and lacks the latest two years of security patches, a knowledge base of known vulnerabilities may be consulted for identifying vulnerabilities known to be effective against that specific version of the operating systems. Any one of the identified known vulnerabilities may then be exploited in order to compromise node 300_{X}. In other examples, first node 300_{X} can be compromised in other ways, such as by causing a user to unwittingly click on a phishing link, or by causing a user to allow execution of a malicious macro in an MS Word® or MS Excel® file.

Once node 300_{X} is compromised, the attacker can get node 300_{X} to download a poisoned executable file from the attacker's website and store it on node 300_{X}. The poisoned executable file can then be spread via one or more data packets sent by first node 300_{X} to second node 300_{Y}. Alternatively, node 300_{X} can send node 300_{Y} a link to a poisoned executable file residing on the cloud on the attacker's server and attempt to cause node 300_{Y} to select it. For example, node 300_{X} may send node 300_{Y} a network message containing a link to a Trojan, attempting to cause node 300_{Y} to download the Trojan malicious code from a known repository of Trojans.

A network node is considered to be compromisable by an attacker if an attack function of a penetration testing system determines that the attacker can successfully cause execution of an operation in the network node that is not allowed for the attacker by the rules defined by an administrator of the network node. A network node is also considered to be compromisable if the attacker can successfully cause execution of an operation in a software module of the network node that was not predicted by the vendor of the software module. A networked system is considered to be compromisable by an attacker if an attack function of a penetration testing system determines that the attacker can compromise at least one network node of the networked system or successfully cause execution of an operation in the networked system that is not allowed for the attacker by the rules defined by an administrator of the networked system.

In the embodiments disclosed herein, the determination that a network node can be compromised may be achieved either with or without risking compromising the networked system during the penetration testing.

In embodiments of the present invention, reconnaissance agents of the penetration testing system may report to the remote computing device of the penetration testing system other data collected in the network nodes hosting the agents, in addition to reporting the sending and receiving of certain network messages that are required for identifying communicating network nodes as described above. The reported other data from the network nodes is analyzed in the remote computing device and used to determine methods for the attacker to compromise the networked system, as is well known in the art of penetration testing systems.

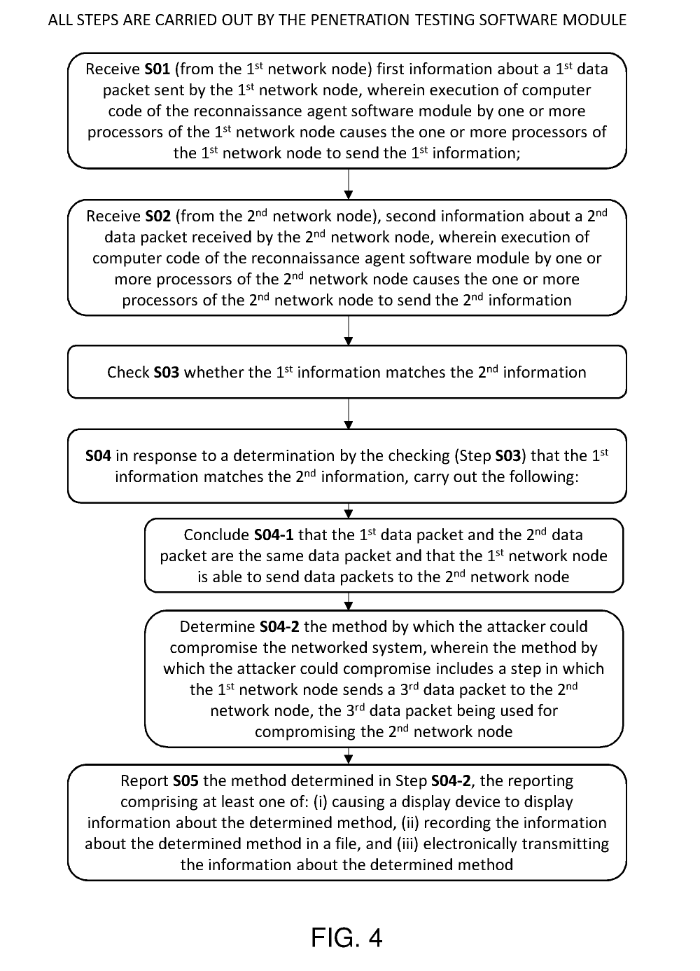

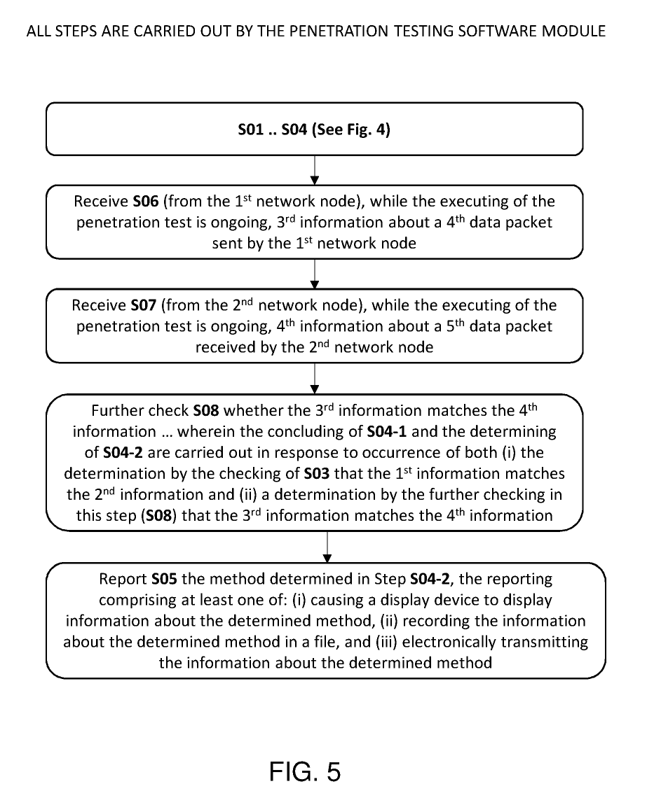

Referring now to FIG. 4, a method is disclosed for executing a computer-implemented penetration test of a networked system 200 by a penetration testing system so as to determine a method by which an attacker could compromise the networked system 200. A penetration testing system suitable for carrying out the method comprises (A) a penetration testing software module (PTSM) 260 installed on a remote computing device 254 and (B) a reconnaissance agent software module (RASM) 270 installed on at least a first network node 300_{X} and a second network node 300_{Y} of the networked system. As illustrated by the flow chart in FIG. 4, the method comprises:
Step S01 Receiving first information from the first network node 300_{X} about a first data packet sent by the first network node 300_{X}. The information is received from the first network node 300_{X} by the PTSM 260; execution of computer code of the RASM 270 by one or more processors of the first network node 300_{X} causes the one or more processors of the first network node 300_{X} to send the first information.
Step S02 Receiving second information from the second network node 300_{Y} about a second data packet received by the second network node 300_{Y}. The information is received from the second network node 300_{Y} by the PTSM 260; execution of computer code of the RASM 270 by one or more processors of the second network node 300_{Y} causes the one or more processors of the second network node 300_{Y} to send the second information.
Step S03 Checking whether the first information matches the second information; the checking is done by the PTSM 260.
Step S04 in response to a determination in Step S03 that the first information matches the second information, carrying out the following sub-steps by the PTSM 260:
Step S04-1 Concluding that the first data packet and the second data packet are the same data packet and that the first network node 300_{X} is able to send data packets to the second network node 300_{Y}; and
Step S04-2 Determining the method by which the attacker could compromise the networked system. The method by which the attacker could compromise includes a step in which the first network node 300_{X} sends a third data packet to the second network node 300_{Y}, the third data packet being used for compromising the second network node 300_{Y}.
Step S05 Reporting the method, determined in Step S04-2, by which the attacker could compromise the networked system. The reporting, done by the PTSM 260, comprises at least one of (i) causing a display device to display a report including information about the determined method by which the attacker could compromise the networked system, (ii) recording the report including the information about the determined method by which the attacker could compromise the networked system in a file, and (iii) electronically transmitting the report including the information about the determined method by which the attacker could compromise the networked system.

In some embodiments, as illustrated in the flow chart in FIG. 5, the method additionally comprises:

Step S06 Receiving, from the first network node 300_{X} while execution of the penetration test is ongoing, third information about a fourth data packet sent by the first network node 300_{X}.
Step S07 Receiving, from the second network node 300_{Y} while execution of the penetration test is ongoing, fourth information about a fifth data packet received by the second network node 300_{Y}.

Step S08 Further checking whether the third information matches the fourth information, wherein the concluding and the determining of Steps S04-1 and S04-2, respectively, are carried out in response to occurrence of both (i) the determination by the checking of Step S03 that the first information matches the second information and (ii) a determination by the further checking (in this step), S08, that the third information matches the fourth information.

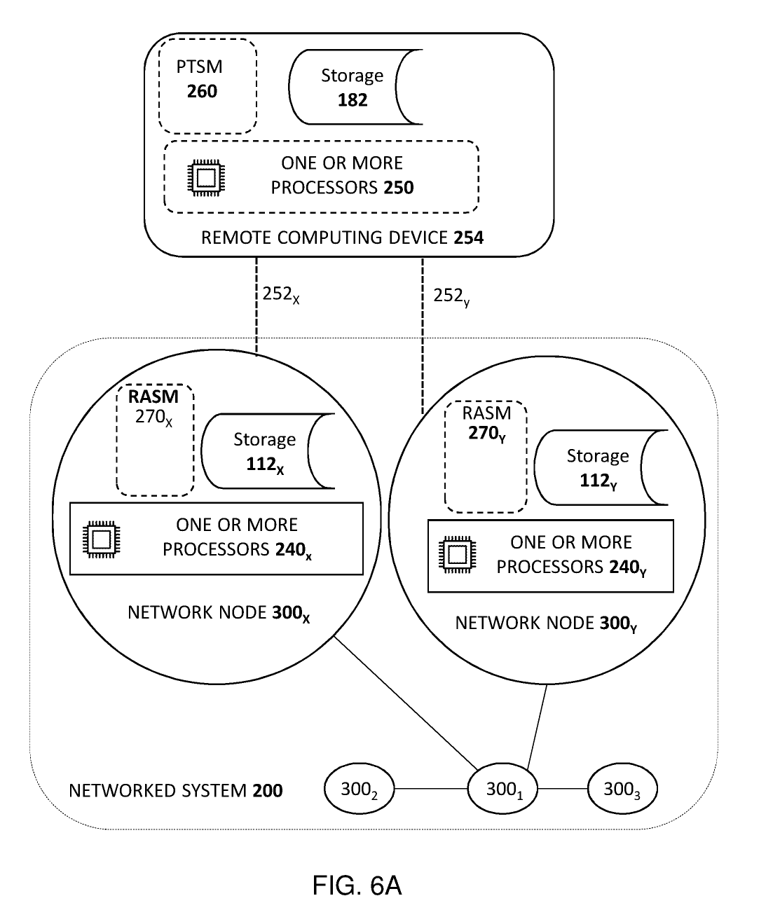

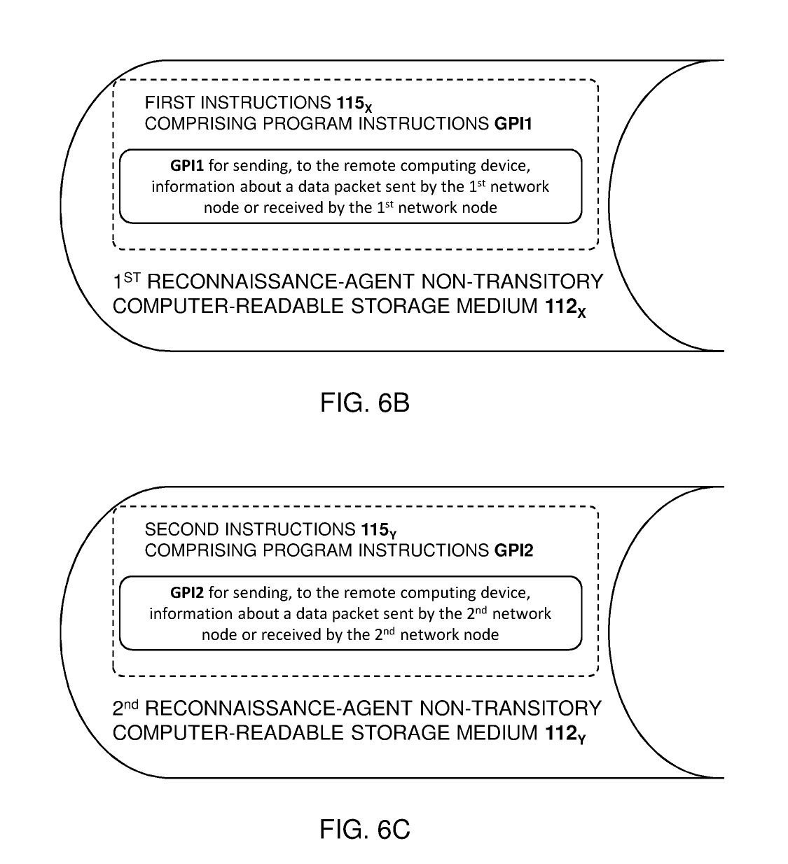

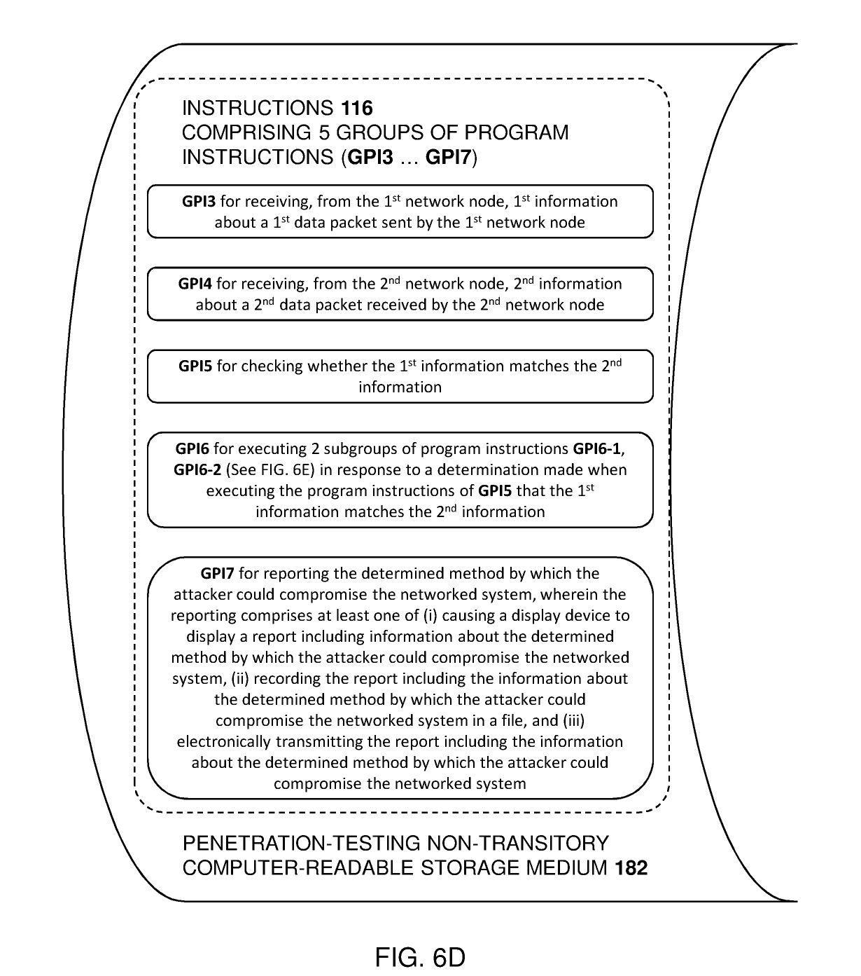

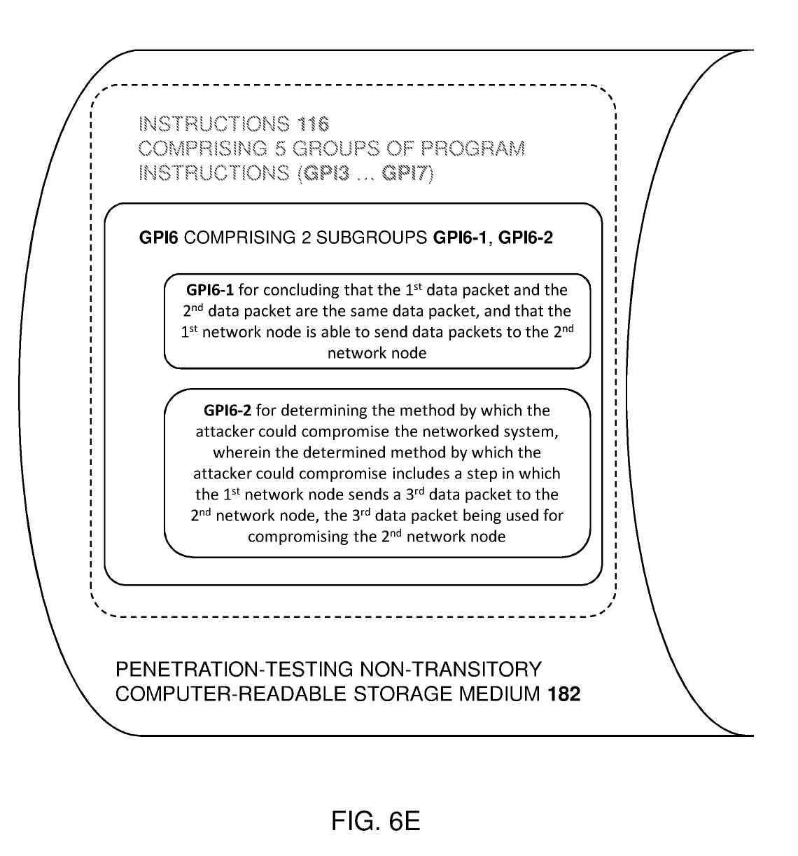

We now refer to FIGS. 6A-6E. A system, for executing a computer-implemented penetration test of a networked system so as to determine a method by which an attacker could compromise the networked system, is schematically illustrated.

Networked system 200, which can be, for example any of the networked systems 200 shown in FIGS. 2 and 3, includes a plurality of network nodes 300. Five nodes 300 (300₁, 300₂, 300₃, 300_{X} and 300_{Y}) are shown, but the networked system can include any number of nodes. The nodes 300 may be connected by a single network, but in some embodiments at least some of the nodes and respective connections can form sub-networks, so that the network 300 is composed of multiple sub-networks that are in communication with each other. For example, 300₂ and 300₁ may be a separate sub-network, with 300₁ being a gateway or a router. Reconnaissance agent software modules 270_{X}, 270_{Y} are installed in first and second network nodes 300_{X}, 300_{Y}. As disclosed earlier, the RASM 270 can be installed in any or all of the network nodes 300.

As illustrated in FIGS. 6A-6E, a penetration testing system comprises:
A first reconnaissance-agent non-transitory computer-readable storage medium 112_{X} which is associated with the first node 300_{X}. This first storage medium 112_{X} is provided for storage of first instructions 115_{X} of the reconnaissance agent software module for execution by one or more processors 240_{X} of the first network node 300_{X}, which is in electronic communication with a remote computing device 254 (by communications arrangement 252_{X} which can be an Internet connection or a LAN connection or any other suitable connection, including an indirect connection). A reconnaissance agent software module 270_{X} is installed in the network node 300_{X}. The first storage medium 112_{X} is shown for convenience as being part of the network node 300_{X} but it can be anywhere as long as the one or more processors 240_{X} can access and execute the instructions 115_{X} stored therein. As shown in the block diagram of FIG. 6B, the first instructions 115_{X} stored in first reconnaissance-agent non-transitory computer-readable storage medium 112_{X}, comprise a first group of program instructions GPI1 for sending, to the remote computing device 254, information about a data packet sent by the first network node 300_{X} or received by the first network node 300_{X}.
A second reconnaissance-agent non-transitory computer-readable storage medium 112_{Y} which is associated with the second node 300_{Y}. This second storage medium 112_{Y} is provided for storage of instructions 115_{Y} of the reconnaissance agent software module for execution by one or more processors 240_{Y} of the second network node 300_{Y}, which is also in electronic communication with a remote computing device 254 (by communications arrangement 252_{Y} which can be the same as communications arrangement 252_{X} or separate and/or different). A reconnaissance agent software module 270_{Y} is installed in the network node 300_{Y}. The second storage medium 112_{Y} is also shown for convenience as being part of the network node 300_{Y} but it can be anywhere as long as the one or more processors 240_{Y} can access and execute the instructions 115_{Y} stored therein. As shown in the block diagram of FIG. 6C, the second instructions 115_{Y} stored in second reconnaissance-agent non-transitory computer-readable storage medium 112_{Y}, comprise a second group of program instructions GPI2 for sending, to the remote computing device 254, information about a data packet sent by the second network node 300_{Y} or received by the second network node 300_{Y}.
A penetration-testing non-transitory computer-readable storage medium 182 for storage of instructions 116 of the penetration testing software module for execution by one or more processors 250 of the remote computing device 254. A penetration testing software module 260 is installed in the remote computing device 254. This storage medium 182 is also shown for convenience as being part of the remote computing device 254 but it can be anywhere as long as the one or more processors 250 can access and execute the instructions 116 stored therein. As illustrated in the block diagrams of FIGS. 6D and 6E, the program instructions 116 comprise 5 groups of program instructions GPI3 . . . GPI7 for execution by the one or more processors 250 of the remote computing device 254:
   Program instructions GPI3 for receiving, from the first network node 300_{X}, first information about a first data packet sent by the first network node 300_{X}
   Program instructions GPI4 for receiving, from the second network node 300_{Y}, second information about a second data packet received by the second network node 300_{Y}
   Program instructions GPI5 for checking whether the first information matches the second information
   Program instructions GPI6 for executing the subgroups of program instructions GPI6-1, GPI6-2 in response to a determination made when executing the program instructions of GPI5 that the first information matches the second information:
      Program instructions GPI6-1 for concluding that the first data packet and the second data packet are the same data packet, and that the first network node 300_{X} is able to send data packets to the second network node 300_{Y}
      Program instructions GPI6-2 for determining the method by which the attacker could compromise the networked system 200, wherein the determined method by which the attacker could compromise the networked system 200 includes a step in which the first network node 300_{X} sends a third data packet to the second network node 300_{Y}, the third data packet being used for compromising the second network node 300_{Y}.
   Program instructions GPI7 for reporting the determined method by which the attacker could compromise the networked system 200, wherein the reporting comprises at least one of (i) causing a display device (not shown) to display a report including information about the determined method by which the attacker could compromise the networked system 200, (ii) recording the report including the information about the determined method by which the attacker could compromise the networked system 200 in a file, and (iii) electronically transmitting the report including the information about the determined method by which the attacker could compromise the networked system 200.

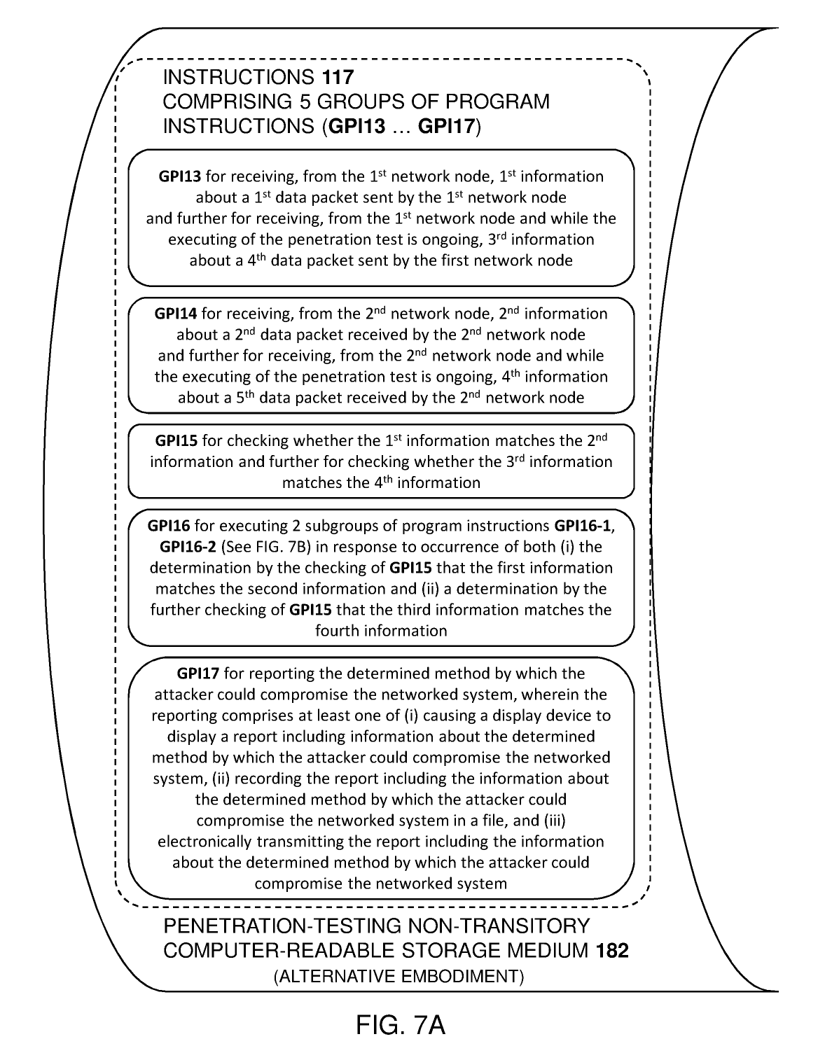

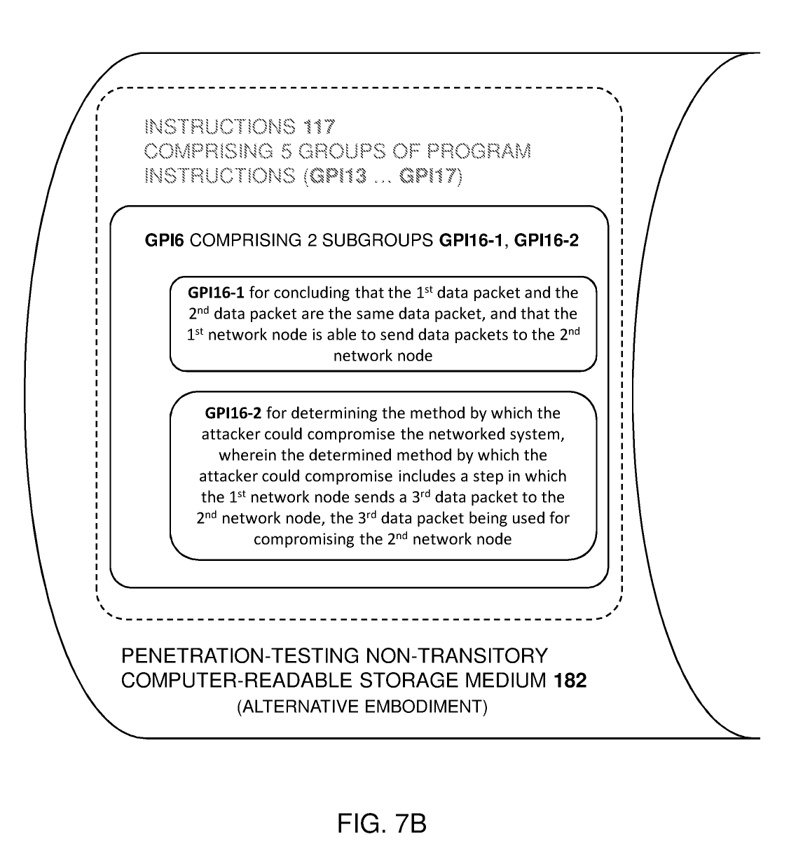

In an alternative embodiment, the penetration-testing non-transitory computer-readable storage medium 182 stores instructions 117 for execution by the one or more processors 250 of the remote computing device 254. As illustrated in the block diagrams of FIGS. 7A and 7B, the program instructions 117 comprise 5 groups of program instructions GPI13 . . . GPI17 for execution by the one or more processors 250 of the remote computing device 254:
Program instructions GPI13 for receiving, from the first network node 300_{X}, first information about a first data packet sent by the first network node 300_{X} and further for receiving, from the first network node 300_{X} and while the executing of the penetration test is ongoing, third information about a fourth data packet sent by the first network node 300_{X}.
Program instructions GPI14 for receiving, from the second network node 300_{Y}, second information about a second data packet received by the second network node 300_{Y} and further for receiving, from the second network node 300_{Y} and while the executing of the penetration test is ongoing, fourth information about a fifth data packet received by the 300_{Y} network node.
Program instructions GPI15 for checking whether the first information matches the second information and further for checking whether the third information matches the fourth information.
Program instructions GPI16 for executing the subgroups of program instructions GPI16-1, GPI16-2 in response to occurrence of both (i) the determination by the checking of Program Instructions GPI15 that the first information matches the second information and (ii) a determination by the further checking of Program Instructions GPI15 that the third information matches the fourth information:
   Program instructions GPI16-1 for concluding that the first data packet and the second data packet are the same data packet, and that the first network node 300_{X} is able to send data packets to the second network node 300_{Y}
   Program instructions GPI16-2 for determining the method by which the attacker could compromise the networked system 200, wherein the determined method by which the attacker could compromise the networked system 200 includes a step in which the first network node 300_{X} sends a third data packet to the second network node, the third data packet being used for compromising the second network node 300_{Y}
Program instructions GPI17 for reporting the determined method by which the attacker could compromise the networked system 200, wherein the reporting comprises at least one of (i) causing a display device (not shown) to display a report including information about the determined method by which the attacker could compromise the networked system 200, (ii) recording the report including the information about the determined method by which the attacker could compromise the networked system 200 in a file, and (iii) electronically transmitting the report including the information about the determined method by which the attacker could compromise the networked system 200.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

Definitions

This disclosure should be interpreted according to the definitions below.

In case of a contradiction between the definitions in this Definitions section and other sections of this disclosure, this section should prevail.

In case of a contradiction between the definitions in this section and a definition or a description in any other document, including in another document incorporated in this disclosure by reference, this section should prevail, even if the definition or the description in the other document is commonly accepted by a person of ordinary skill in the art.
1. “computing device”—Any device having a processing unit into which it is possible to install code that can be executed by the processing unit. The installation of the code may be possible even while the device is operative in the field or it may be possible only in the factory.
2. “peripheral device”—Any device, whether a computing device or not, that provides input or output services to at least one other device that is a computing device. Examples of peripheral devices are printers, plotters, scanners, environmental sensors, smart-home controllers, digital cameras, speakers and display screens. A peripheral device may be directly connected to a single computing device or may be connected to a communication system through which it can communicate with one or more computing devices. A storage device that is (i) not included in or directly connected to a single computing device, and (ii) accessible by multiple computing devices, is a peripheral device.
3. “network” or “computing network”—A collection of computing devices and peripheral devices which are all connected to common communication means that allow direct communication between any two of the devices without requiring passing the communicated data through a third device. The network includes both the connected devices and the communication means. A network may be wired or wireless or partially wired and partially wireless.
4. “networked system” or “networked computing system”—One or more networks that are interconnected so that communication is possible between any two devices of the one or more networks, even if they do not belong to the same network. The connection between different networks of the networked system may be achieved through dedicated computing devices, and/or through computing devices that belong to multiple networks of the networked system and also have other functionality in addition to connecting between networks. The networked system includes the one or more networks, any connecting computing devices and also peripheral devices accessible by any computing device of the networked system. Note that a single network is a networked system having only one network, and therefore a network is a special case of a networked system.
5. “module”—A portion of a system that implements a specific task. A module may be composed of hardware, software or any combination of both. For example, in a module composed of both hardware and software, the hardware may include a portion of a computing device, a single computing device or multiple computing devices, and the software may include software code executed by the portion of the computing device, by the single computing device or by the multiple computing devices. A computing device associated with a module may include one or more processors and computer readable storage medium (non-transitory, transitory or a combination of both) for storing instructions or for executing instructions by the one or more processors.
6. “network node of a networked system” or “node of a networked system”—Any computing device or peripheral device that belongs to the networked system.
7. “security vulnerability of a network node” or “vulnerability of a network node”—A weakness which allows an attacker to compromise the network node. A vulnerability of a network node may be caused by one or more of a flawed configuration of a component of the network node, a flawed setting of a software module in the network node, a bug in a software module in the network node, a human error while operating the network node, having trust in an already-compromised other network node, and the like.
   A weakness that allows an attacker to compromise a network node only conditionally, depending on current conditions in the network node or in the networked system in which the network node resides, is still a vulnerability of the network node, but may also be referred to as a “potential vulnerability of the network node”. For example, a vulnerability that compromises any network node running the Windows 7 Operating System, but only if the network node receives messages through a certain Internet port, can be said to be a vulnerability of any Windows 7 network node, and can also be said to be a potential vulnerability of any such node. Note that in this example the potential vulnerability may fail in compromising the node either because the certain port is not open (a condition in the node) or because a firewall is blocking messages from reaching the certain port in the node (a condition of the networked system).
8. “security vulnerability of a networked system” or “vulnerability of a networked system”—A weakness which allows an attacker to compromise the networked system. A vulnerability of a networked system may be caused by one or more of a vulnerability of a network node of the networked system, a flawed configuration of a component of the networked system, a flawed setting of a software module in the networked system, a bug in a software module in the networked system, a human error while operating the networked system, and the like.
   A weakness that allows an attacker to compromise a networked system only conditionally, depending on current conditions in the networked system, is still a vulnerability of the networked system, but may also be referred to as a “potential vulnerability of the networked system”. For example, if a network node of the networked has a potential vulnerability then that vulnerability can be said to be a vulnerability of the networked system, and can also be said to be a potential vulnerability of the networked system.
9. “validating a vulnerability” or “validating a potential vulnerability” (for a given network node or for a given networked system)—Verifying that the vulnerability compromises the given network node or the given networked system under the conditions currently existing in the given network node or the given networked system.
   The validation of the vulnerability may be achieved by actively attempting to compromise the given network node or the given networked system and then checking if the compromising attempt was successful. Such validation is referred to as “active validation”.
   Alternatively, the validation of the vulnerability may be achieved by simulating the exploitation of the vulnerability or by otherwise evaluating the results of such exploitation without actively attempting to compromise the given network node or the given networked system. Such validation is referred to as “passive validation”.
10. “vulnerability management”—A cyclical practice of identifying, classifying, remediating, and mitigating vulnerabilities of network nodes in a networked system.
11. “penetration testing” or “pen testing” (in some references also known as “red team assessment” or “red team testing”, but in other references those terms referring to a red team have a different meaning than “penetration testing”)—A process in which a networked system is evaluated in order to determine if it can be compromised by an attacker by utilizing one or more security vulnerabilities of the networked system. If it is determined that the networked system can be compromised, then the one or more security vulnerabilities of the networked system are identified and reported.
   Unlike a vulnerability management process which operates at the level of isolated vulnerabilities of individual network nodes, a penetration test may operate at a higher level which considers vulnerabilities of multiple network nodes that might be jointly used by an attacker to compromise the networked system.
   A penetration testing process involves at least the following functions: (i) a reconnaissance function, (ii) an attack function, and (ii) a reporting function. It should be noted that the above functions do not necessarily operate sequentially according to the above order, but may operate in parallel or in an interleaved mode.
   Unless otherwise explicitly specified, a reference to penetration testing should be understood as referring to automated penetration testing.
12. “automated penetration testing”—Penetration testing in which at least one of the reconnaissance function, the attack function and the reporting function is at least partially automated.
13. “penetration testing system”—A system capable of performing penetration testing, regardless if composed of hardware, software or combination of both.
14. “reconnaissance function” or “recon function”—The function in a penetration testing process that handles collection of data about the tested networked system. The collected data may include internal data of one or more network nodes of the tested networked system. Additionally, the collected data may include data about communication means of the tested networked system and about peripheral devices of the tested networked system. The collected data may also include data that is only indirectly related to the tested networked system, for example business intelligence data about the organization owning the tested networked system, collected in order to use it for assessing importance of resources of the networked system.
   The functionality of a reconnaissance function may be implemented by any combination of (i) software executing in a remote computing device, where the remote computing device may probe the tested networked system for the purpose of collecting data about it, (ii) hardware and/or software simulating or duplicating the tested networked system, (iii) a reconnaissance agent software module executing in one or more network nodes of the tested networked system.
15. “attack function”—The function in a penetration testing process that handles determination of whether one or more security vulnerabilities exist in the tested networked system. The determination is based on data collected by the reconnaissance function of the penetration testing. The attack function generates data about each of the identified security vulnerabilities, if any.
   The functionality of an attack function may be implemented by any combination of (i) software executing in a remote computing device, where the remote computing device may attack the tested networked system for the purpose of verifying that it can be compromised, (ii) hardware and/or software simulating or duplicating the tested networked system, (iii) an attack agent software module executing in one or more network nodes of the tested networked system.
   The methods used by an attack function may include executing a real attack on the tested networked system by attempting to change at least one setting, mode or state of a network node or of a hardware or software component of a network node, in order to verify that the tested networked system may be compromised. In such case, the attempt may result in actually compromising the tested networked system. Alternatively, the methods used by an attack function may be such that whenever there is a need to verify whether a setting, a mode or a state of a network node or of a hardware or software component of a network node can be changed in a way that compromises the tested networked system, the verification is done by simulating the effects of the change or by otherwise evaluating them without ever actually compromising the tested networked system.
16. “reporting function”—The function in a penetration testing process that handles reporting of results of the penetration testing. The reporting comprises at least one of (i) causing a display device to display a report including information about the results of the penetration testing, (ii) recording a report including information about the results of the penetration testing in a file, and (ii) electronically transmitting a report including information about the results of the penetration testing.
   The functionality of a reporting function may be implemented by software executing in a remote computing device, for example in the computing device implementing the attack function of the penetration testing.
17. “recovery function” or “clean-up function”—The function in a penetration testing process that handles cleaning-up after a penetration test. The recovery includes undoing any operation done during the penetration testing process that results in compromising the tested networked system.
   The functionality of a recovery function may be implemented by any combination of (i) software executing in a remote computing device, for example in the computing device implementing the attack function of the penetration testing, (ii) an attack agent software module executing in one or more network nodes of the tested networked system.
18. “a campaign of penetration testing” or “penetration testing campaign”—A specific run of a specific test of a specific networked system by the penetration testing system.
19. “results of a penetration testing campaign”—Any output generated by the penetration testing campaign. This includes, among other things, data about any security vulnerability of the networked system tested by the penetration testing campaign that is detected by the campaign. It should be noted that in this context the word “results” is used in its plural form regardless of the amount of output data generated by the penetration testing campaign, including when the output consists of data about a single security vulnerability.
20. “information item of a campaign”—A variable data item that a penetration testing system must know its value before executing the campaign. Note that a data item must be able to have different values at different campaigns in order to be considered an information item of the campaign. If a data item always has the same value for all campaigns, it is not an information item of the campaign, even if it must be known and is being used by the penetration testing system when executing the campaign.
   An information item of a campaign is either a primary information item of the campaign or a secondary information item of the campaign.
   A type of an attacker and a goal of an attacker are examples of information items of a campaign. Another example of an information item of a campaign that is more complex than the previous two simple examples is a subset of the network nodes of the networked system that is assumed to be already compromised at the time of beginning the penetration testing campaign, with the subset defined either by an explicit selection of network nodes or by a Boolean condition each node of the subset has to satisfy.
   A value of an information item may be composed either of a simple value or of both a main value and one or more auxiliary values. If a specific main value of an information item requires one or more auxiliary values that complete the full characterization of the value, then the combination of the main value and the one or more auxiliary values together is considered to be the value assigned to the information item. For example, for a “goal of the attacker” information item, after a user selects a main value of “exporting a specific file from whatever node having a copy of it”, the user still has to provide a file name as an auxiliary value in order for the goal information item to be fully characterized. In this case the combination of “exporting a specific file from whatever node having a copy of it” and the specific file name is considered to be the value of the “goal of the attacker” information item.
21. “primary information item of a campaign”—An information item of the campaign which is completely independent of previously selected values of other information items of the campaign. In other words, the options available to a user for selecting the value of a primary information item of the campaign are not dependent on any value previously selected for any another information item of the campaign. For example, the options available to the user for selecting a goal of the attacker are independent of values previously selected for any other information item of the campaign, and therefore the goal of the attacker is a primary information item of the campaign.
22. “secondary information item of a campaign”—An information item of the campaign which depends on at least one previously selected value of another information item of the campaign. In other words, the options available to a user for selecting the value of a secondary information item of the campaign depend on at least one value previously selected for another information item of the campaign. For example, the options available to the user for selecting a capability of an attacker may depend on the previously selected value of the type of the attacker. For a first type of attacker the available capabilities to select from may be a first group of capabilities, while for a second type of attacker the available capabilities to select from may be a second group of capabilities, different from the first group. Therefore, a capability of the attacker is a secondary information item of the campaign.
23. “specifications of a campaign” or “scenario”—A collection of values assigned to all information items of the campaign. As having a value for each information item of a campaign is essential for running it, a campaign of a penetration testing system cannot be run without providing the penetration testing system with full specifications of the campaign. A value of an information item included in the specifications of a campaign may be manually selected by a user or may be automatically determined by the penetration testing system. In the latter case, the automatic determination by the system may depend on one or more values selected by the user for one or more information items of the campaign, or it may be independent of any selection by the user. For example, the selection of the capabilities of the attacker may automatically be determined by the system based on the user-selected type of the attacker, and the lateral movement strategy of the attacker may be automatically determined by the system independently of any user selection.
24. “pre-defined scenario”, “scenario template” or “template scenario”—A scenario that exists in storage accessible to a penetration testing system before the time a campaign is started, and can be selected by a user of the penetration testing system for defining a campaign of penetration testing.
   A pre-defined scenario may be created and provided by the provider of the penetration testing system and may be part of a library of multiple pre-defined scenarios. Alternatively, a pre-defined scenario may be created by the user of the penetration testing system using a scenario editor provided by the provider of the penetration testing system.
   A penetration testing system may require that a campaign of penetration testing that is based on a pre-defined scenario must have all its values of information items taken from the pre-defined scenario, with no exceptions. Alternatively, a penetration testing system may allow a user to select a pre-defined scenario and then override and change one or more values of information items of a campaign that is based on the pre-defined scenario.
25. “attacker” or “threat actor”—An entity, whether a single person, a group of persons or an organization, that might conduct an attack against a networked system by penetrating it for uncovering its security vulnerabilities and/or for compromising it.
26. “a type of an attacker”—A classification of the attacker that indicates its main incentive in conducting attacks of networked systems. Typical values for a type of an attacker are state-sponsored, opportunistic cyber criminal, organized cyber criminal and insider.
   An attacker can have only a single type.
27. “a capability of an attacker”—A tool in the toolbox of the attacker. A capability describes a specific action that the attacker can perform. Examples of capabilities are copying a local file of a network node and exporting it to the attacker out of the networked system and remotely collecting database information from an SQL server of the networked system. In some systems, selecting a type of an attacker causes a corresponding default selection of capabilities for that type of attacker, but the user may have an option to override the default selection and add or delete capabilities.
   An attacker can have one or multiple capabilities.
28. “a goal of an attacker”—What the attacker of a campaign is trying to achieve when attacking a targeted networked system. In other words, what is the criterion according to which it will be judged whether the attack was a success or a failure and/or to what extent was it a success or a failure. Selecting a type of an attacker may cause a default selection of a goal for that attacker, but the user may have an option to override the default selection. An attacker can have one or multiple goals.
29. “a lateral movement strategy of an attacker”—A decision logic applied by the attacker of a campaign for selecting the next network node to try to compromise. During a penetration testing campaign, the attacker is assumed to make progress by an iterative process in which in each iteration he selects the next node to attack, based on the group of network nodes he already controls (i.e. that are already compromised). If the attack on the selected node is successful, that node is added to the group of nodes that are already compromised, and another iteration starts. If the attempt to compromise the selected node fails, another node is selected, either according to some other rule or randomly.
   It should be noted that all types of penetration testing systems, whether using simulated penetration testing, actual attack penetration testing or some other form of penetration testing, must use a lateral movement strategy. In the case of a penetration testing system that actually attacks the tested networked system, the lateral movement strategy selects the path of attack actually taken through the networked system. In the case of a penetration testing system that simulates or evaluates the results of attacking the tested networked system, the lateral movement strategy selects the path of attack taken in the simulation or the evaluation through the networked system. Therefore in the above explanation, the term “attack” should be understood to mean “actual attack or simulated attack”, the term “already controls” should be understood to mean “already controls or already determined to be able to control”, the term “already compromised” should be understood to mean “already compromised or already determined to be compromisable”, etc.
   A simple example of a lateral movement strategy is a “depth first” strategy. In such strategy, the next network node to try to compromise is an immediate neighbor of the last network node that was compromised that is not yet compromised (provided such neighbor node exists). Two network nodes are “immediate neighbors” of each other if and only if they have a direct communication link between them that does not pass through any other network node.
   Another simple example is a “breadth search” strategy. In such strategy, the next network node to try to compromise is a network node whose distance from the first node compromised by the campaign is the smallest possible. The distance between two network nodes is the number of network nodes along the shortest path between them, plus one. A path is an ordered list of network nodes in which each pair of adjacent nodes in the list is a pair of immediate neighbors. Thus, the distance between two immediate neighbors is one.
   An example of a more advanced lateral movement strategy is a strategy that is applicable when a goal of the attacker is related to a resource of the networked system that resides in a specific network node. In such case the next network node to try to compromise may be selected by determining the shortest path in the networked system leading from an already compromised node to the specific node containing the desired resource, and picking the first node on this path to be the next node to try to compromise. Note that if the shortest path has a length of one (which happens when the specific node is an immediate neighbor of an already compromised node), then the next node to try to compromise is the specific node containing the desired resource. Another example of a lateral movement strategy is a strategy that gives priority to network nodes satisfying a specific condition, for example nodes that are known to have a specific weakness, such as running the Windows XP operating system. In such case the next node to try to compromise is a node that satisfies the condition and is also an immediate neighbor of an already compromised node (if such node exists). Selecting a type of an attacker may cause a default selection of a lateral movement strategy for that attacker, but the user may have an option to override the default selection.
   An attacker can only have a single lateral movement strategy.
30. “penetration testing by simulation” or “simulated penetration testing”—Penetration testing in which (i) the functionality of the reconnaissance function is fully implemented by software executing by a remote computing device and/or by hardware and/or software simulating or duplicating the tested networked system, where the remote computing device may probe the tested networked system for the purpose of collecting data about it, as long as this is done without risking compromising the tested networked system, and (ii) the methods used by the attack function are such that whenever there is a need to verify whether a setting, a mode or a state of a network node or of a hardware or software component of a network node can be changed in a way that compromises the tested networked system, the verification is done by simulating the effects of the change or by otherwise evaluating them without risking compromising the tested networked system.
31. “penetration testing by actual attack” or “actual attack penetration testing” or “penetration testing by actual exploit” or “actual exploit penetration testing”—Penetration testing in which (i) the functionality of the reconnaissance function is fully implemented by (A) software executing in a remote computing device, where the remote computing device may probe the tested networked system for the purpose of collecting data about it even if this risks compromising the tested networked system, and/or by (B) software executing in one or more network nodes of the tested networked system that analyzes network traffic and network packets of the tested networked system for collecting data about it, and (ii) the methods used by the attack function include executing a real attack on the tested networked system by attempting to change at least one setting, mode or state of a network node or of a hardware or software component of a network node in order to verify that the tested networked system may be compromised, such that the attempt may result in compromising the tested networked system.
32. “penetration testing by reconnaissance agents” or “reconnaissance agent penetration testing”—Penetration testing in which (i) the functionality of the reconnaissance function is at least partially implemented by a reconnaissance agent software module installed and executed in each one of multiple network nodes of the tested networked system, where the data collected by at least one instance of the reconnaissance agent software module includes internal data of the network node in which it is installed, and the data collected by at least one instance of the reconnaissance agent software module is at least partially collected during the penetration testing process, and (ii) the methods used by the attack function are such that whenever there is a need to verify whether a setting, a mode or a state of a network node or of a hardware or software component of a network node can be changed in a way that compromises the tested networked system, this is done by simulating the effects of the change or by otherwise evaluating them without risking compromising the tested networked system.
33. “reconnaissance client agent”, “reconnaissance agent” or “recon agent”—A software module that can be installed on a network node and can be executed by a processor of that network node for partially or fully implementing the reconnaissance function of a penetration test. A reconnaissance agent must be capable, when executed by a processor of the network node in which it is installed, of collecting data at least about some of the events occurring in the network node. Such events may be internal events of the network node or messages sent out of the network node or received by the network node. A reconnaissance agent may be capable of collecting data about all types of internal events of its hosting network node. Additionally, it may be capable of collecting other types of data of its hosting network node. A reconnaissance agent may additionally be capable of collecting data about other network nodes or about other components of a networked system containing the hosting network node. A reconnaissance agent may be persistently installed on a network node, where “persistently” means that once installed on a network node the reconnaissance agent survives a reboot of the network node. Alternatively, a reconnaissance agent may be non-persistently installed on a network node, where “non-persistently” means that the reconnaissance agent does not survive a reboot of the network node and consequently should be installed again on the network node for a new penetration test in which the network node takes part, if the network node was rebooted since the previous penetration test in which it took part.
34. “attack client agent” or “attack agent”—A software module that can be installed on a network node and can be executed by a processor of that network node for partially or fully implementing the attack function of a penetration test. Typically, an attack agent is installed by an actual attack penetration testing system in a network node that it had succeeded to compromise during a penetration test. Once installed on such network node, the attack agent may be used as a tool for compromising other network nodes in the same networked system. In such case, the attack agent may include code that when executed by a processor of the compromised network node compromises another network node that is adjacent to it in the networked system, possibly taking advantage of the high level of trust it may have from the point of view of the adjacent network node. Another type of an attack agent may include code that when executed by a processor of a network node determines whether that network node would be compromised if a given operation is performed.
35. “penetration testing software module” or “remote computing device penetration testing software module”—A software module that implements the full functionality of a penetration testing system, except for the functionality implemented by (i) reconnaissance agents, (ii) attack agents, and (iii) hardware and/or software simulating or duplicating the tested networked system, if such components are used in the implementation of the penetration testing system. The penetration testing software module may be installed and executed on a single computing device or comprise multiple software components that reside on multiple computing devices. For example, a first component of the penetration testing software module may implement part or all of the reconnaissance function and be installed and executed on a first computing device, a second component of the penetration testing software module may implement part or all of the attack function and be installed and executed on a second computing device, and a third component of the penetration testing software module may implement the reporting function and be installed and executed on a third computing device.
36. “internal data of a network node”—Data related to the network node that is only directly accessible to code executing by a processor of the network node and is only accessible to any code executing outside of the network node by receiving it from code executing by a processor of the network node. Examples of internal data of a network node are data about internal events of the network node, data about internal conditions of the network node, and internal factual data of the network node.
37. “internal event of/in a network node”—An event occurring in the network node whose occurrence is only directly detectable by code executing by a processor of the network node. Examples of an internal event of a network node are an insertion of a USB drive into a port of the network node, and a removal of a USB drive from a port of the network node. An internal event may be a free event or a non-free event.
   It should be noted that the term “an event of X” refers to any occurrence of an event of the type X and not to a specific occurrence of it. For referring to a specific occurrence of an event of type X one should explicitly say “an occurrence of event of X”. Thus, a software module which looks for detecting insertions of a USB drive into a port is “detecting an event of USB drive insertion”, while after that module had detected such event it may report “an occurrence of an event of USB drive insertion”.
38. “internal condition of/in a network node”—A Boolean condition related to the network node which can only be directly tested by code executing by a processor of the network node. Examples of an internal condition of a network node are whether the local disk of the terminal node is more than 98% full or not, and whether a USB drive is currently inserted in a port of the network node.
39. “internal factual data of/in a network node” or “internal facts of a network node”—Facts related to the network node which can only be directly found by code executing by a processor of the network node. Examples of factual data of a network node are the version of the firmware of a solid-state drive installed in the network node, the hardware version of a processor of the network node, and the amount of free space in a local disk of the network node.
40. “resource of a networked system”—A file in a network node of the networked system, a folder in a network node of the networked system, credentials of a user of the networked system, a peripheral device of a network node of the networked system, or a peripheral device directly attached to a network of the networked system.
41. “compromising a network node”—Successfully causing execution of an operation in the network node that is not allowed for the entity requesting the operation by the rules defined by an administrator of the network node, or successfully causing execution of code in a software module of the network node that was not predicted by the vendor of the software module. Examples for compromising a network node are reading a file without having read permission for it, modifying a file without having write permission for it, deleting a file without having delete permission for it, exporting a file out of the network node without having permission to do so, getting an access right higher than the one originally assigned without having permission to get it, getting a priority higher than the one originally assigned without having permission to get it, changing a configuration of a firewall network node such that it allows access to other network nodes that were previously hidden behind the firewall without having permission to do it, and causing execution of software code by utilizing a buffer overflow. As shown by the firewall example, the effects of compromising a certain network node are not necessarily limited to that certain network node. In addition, executing successful ARP spoofing, denial-of-service, man-in-the-middle or session-hijacking attacks against a network node are also considered compromising that network node, even if not satisfying any of the conditions listed above in this definition.
42. “ARP spoofing”—a technique for compromising a target network node in which an attacker sends a false Address Resolution Protocol (ARP) reply message to the target network node. The aim is to associate an attacker's MAC address (either a MAC address of the node sending the false ARP reply message or a MAC address of another node controlled by the attacker) with the IP address of another host, such as the default gateway, causing any traffic sent by the target node and meant for that IP address to be sent to the attacker instead. ARP spoofing may allow an attacker to intercept data frames on a network, modify the traffic, or stop all traffic to a certain node. Often the attack is used as an opening for other attacks, such as denial-of-service, man-in-the-middle, or session-hijacking attacks.
43. “denial-of-service attack”—a cyber-attack where an attacker seeks to make a service provided by a network node to other network nodes unavailable to its intended users either temporarily or indefinitely. The denial-of-service attack may be accomplished by flooding the node providing the targeted service with superfluous requests in an attempt to overload it and prevent some or all legitimate requests from being fulfilled. Alternatively, the denial-of-service attack may be accomplished by causing some or all of the legitimate requests addressed to the targeted service to not reach their destination.
44. “man-in-the-middle attack”—a cyber-attack where an attacker secretly relays and possibly alters the communication between two network nodes who believe they are directly communicating with each other. One example of man-in-the-middle attacks is active eavesdropping, in which the attacker makes independent connections with the victims and relays messages between them to make them believe they are communicating directly with each other, when in fact the entire communication session is controlled by the attacker. The attacker must be able to intercept all relevant messages passing between the two victims and inject new ones.
45. “session-hijacking attack”—a cyber-attack where a valid communication session between two network nodes in a networked system is used by an attacker to gain unauthorized access to information or services in the networked computer system.
46. “compromising a networked system”—Compromising at least one network node of the networked system or successfully causing execution of an operation in the networked system that is not allowed for the entity requesting the operation by the rules defined by an administrator of the networked system. Examples for operations in the networked system that may not be allowed are exporting a file out of the networked system without having permission to do so, sending a file to a network printer without having permission to do so, and copying a file from one network node to another network node without having permission to do so.
47. “compromising a software application”—Successfully causing the software application to execute an operation that is not allowed for the entity requesting the operation by the rules defined by an administrator of the network node on which the software application is installed or by a vendor of the software application, or successfully causing the execution of code in the software application that was not predicted by the vendor of the software application. Examples for compromising a software application are changing a configuration file controlling the operation of the software application without having permission for doing so, and activating a privileged function of the software application without having permission for doing so. In addition, causing the software application to execute a macro without checking rights of the macro code to do what it is attempting to do is also considered compromising that software application, even if not satisfying any of the conditions listed above in this definition.
48. “administrator of a network node”—Any person that is authorized, among other things, to define or change at least one rule controlling at least one of an access right, a permission, a priority and a configuration in the network node.
49. “administrator of a networked system”—Any person that is authorized, among other things, to define or change at least one rule controlling at least one of an access right, a permission, a priority and a configuration in the networked system. Note that an administrator of a networked system may also be an administrator of one or more of the network nodes of the networked system.
50. “remote computing device” (with respect to a given networked system)—A computing device that executes software implementing part or all of the penetration testing software module that is used for testing the given networked system.
   A remote computing device may be (i) outside of the given networked system, or (ii) inside the given networked system. In other words, a remote computing device is not necessarily physically remote from the given networked system. It is called “remote” to indicate its functionality is logically separate from the functionality of the given networked system.
   A remote computing device may (i) be a dedicated computing device that is dedicated only to doing penetration testing, or (ii) also implement other functionality not directly related to penetration testing.
   A remote computing device is not limited to be a single physical device with a single processing unit. It may be implemented by multiple separate physical devices packaged in separate packages that may be located at different locations. Each of the separate physical devices may include one or multiple processing units.
   A remote computing device may be (i) a physical computing device, or (ii) a virtual machine running inside a physical computing device on top of a hosting operating system.
51. “explicitly selecting”—Directly and clearly selecting, by a human user, of one option out of multiple options available to human user, leaving no room for doubt and not relying on making deductions by a computing device.
   Examples of explicit selections are (i) selection of a specific type of an attacker from a drop-down list of types, (ii) selection of specific one or more attacker capabilities by marking one or more check boxes in a group of multiple check boxes corresponding to multiple attacker capabilities, and (iii) reception for viewing by a user of a recommendation automatically computed by a computing device for a value of an information item and actively approving by the user of the recommendation for using the value, provided that the approving user has an option of rejecting the recommendation and selecting a different value for the information item.
   Examples of selections that are not explicit selections are (i) selection of specific one or more attacker capabilities by selecting a specific scenario of a penetration testing system from a pre-defined library of scenarios, where the specific scenario includes an attacker having the one or more capabilities, and (ii) selection of specific one or more attacker capabilities by selecting a specific goal of an attacker, accompanied by a deduction by a computing device concluding that the specific one or more attacker capabilities must be selected because they are essential for the attacker to succeed in meeting the specific goal.
52. “automatically selecting”—Selecting, by a computing device, of one option out of multiple options, without receiving from a human user an explicit selection of the selected option. It should be noted that the selecting of an option is an automatic selecting even if the computing device is basing the selection on one or more explicit selections by the user, as long as the selected option itself is not explicitly selected by the user. It should also be noted that receiving from a user of an approval for a recommendation which is otherwise automatically selected without giving the user an ability to override the recommendation does not make the selection a non-automatic selection.
   An example of an automatic selection is a selection by a computing device of one or more attacker capabilities by (a) receiving from a user an explicit selection of a specific scenario of a penetration testing system from a pre-defined library of scenarios, (b) determining by the computing device that the specific scenario includes an attacker having the one or more capabilities, and (c) deducing by the computing device that the user wants to select the one or more attacker capabilities.
   An example of a selection that is not an automatic selection is a selection of a value for an information item by (a) calculating by a computing device of a recommended value for the information item, (b) displaying the recommendation to a user, and (c) receiving from the user an explicit approval to use the recommended value of the information item, provided that the approving user has an option of rejecting the recommendation and selecting a different value for the information item.
53. “user interface”—A man-machine interface that does at least one of (i) providing information to a user, and (ii) receiving input from the user. Towards this end, any user interface includes at least one of (i) an input device (e.g. touch-screen, mouse, keyboard, joystick, camera) for receiving input from the user, and (ii) an output device (e.g. display screen such as a touch-screen, speaker) for providing information to the user. A user interface typically also includes executable user-interface code for at least one of (i) causing the output device to provide information to the user (e.g. to display text associated with radio-buttons or with a check list, or text of a drop-down list) and (ii) processing user-input received via the input device.
   In different examples, the executable code may be compiled-code (e.g. in assembly or machine-language), interpreted byte-code (e.g. Java byte-code), or browser-executed code (e.g. JavaScript code) that may be sent to a client device from a remote server and then executed by the client device.
54. “user interface of a computing device”—A user interface that is functionally attached to the computing device and serves the computing device for interacting with the user.
   An input device of a user interface of a computing device may share a common housing with the computing device (e.g. a touch-screen of a tablet), or may be physically separate from the computing device and be in communication with it, either through a physical port (e.g. a USB port) or wirelessly (e.g. a wireless mouse).
   An output device of a user interface of a computing device may share a common housing with the computing device (e.g. a touch-screen of a tablet), or may be physically separate from the computing device and be in communication with it, either through a physical port (e.g. an HDMI port) or wirelessly.
   User-interface code of a user interface of a computing device is stored in a memory accessible to the computing device and is executed by one or more processors of the computing device. In one example related to web-based user interfaces, at least some of this code may be received from a remote server and then locally executed by the computing device which functions as a client. In another example related to locally-implemented user interfaces, all of the user-interface code is pre-loaded onto the computing device.
55. “random selection”—A selection that depends on a random or pseudo-random factor. Different possible outcomes in a random selection do not necessarily have the same probabilities to be selected.
56. “hash function”—any function that maps data of fixed or arbitrary size to data of fixed size, where the output in smaller in size than the input. For example, the function D=A XOR B XOR C (where A, B, C and D are all 32 bit unsigned numbers) is a hash function, as it maps an input of size 3×32=96 bits to an output of size 32 bits. The output of a hash function is called “a hash value” or simply “a hash”.
57. “or”—A logical operator combining two Boolean input conditions into a Boolean compound condition, such that the compound condition is satisfied if and only if at least one of the two input conditions is satisfied. In other words, if condition C=condition A or condition B, then condition C is not satisfied when both condition A and condition B are not satisfied, but is satisfied in each of the following cases: (i) condition A is satisfied and condition B is not satisfied, (ii) condition A is not satisfied and condition B is satisfied, and (iii) both condition A and condition B are satisfied.
58. “data packet”—A formatted unit of data carried by a computer network.
59. “data packet of a network node”—A data packet that is either sent by the network node or received by the network node.
60. “first information matches second information”—The first information and the second information jointly satisfy a given Boolean condition involving both the first and the second information.
   Examples of a Boolean condition involving first and second information are:
      a. A given field of the first information equals the corresponding field of the second information.
      b. A given field of the first information does not equal the corresponding field in the second information.
      c. Each given field of multiple given fields of the first information equals the corresponding field of the second information.
      d. A result of a given calculation performed on given one or more fields of the first information equals a result of the given calculation performed over the corresponding fields of the second information.
      e. The absolute value of the difference between the value of a given field of the first information and the value of the corresponding field of the second information is smaller than a given threshold.

1. A method for executing a computer-implemented penetration test of a networked system by a penetration testing system so as to determine a method by which an attacker could compromise the networked system, where the penetration testing system comprises (A) a penetration testing software module installed on a remote computing device and (B) a reconnaissance agent software module installed on at least a first network node and a second network node of the networked system, the method for executing the computer-implemented penetration test comprising:
a. receiving, by the penetration testing software module and from the first network node, first information about a first data packet sent by the first network node, wherein execution of computer code of the reconnaissance agent software module by one or more processors of the first network node causes the one or more processors of the first network node to send the first information;
b. receiving, by the penetration testing software module and from the second network node, second information about a second data packet received by the second network node, wherein execution of computer code of the reconnaissance agent software module by one or more processors of the second network node causes the one or more processors of the second network node to send the second information;
c. checking, by the penetration testing software module, whether the first information matches the second information;
d. in response to a determination by the checking that the first information matches the second information, carrying out the following steps:
i. concluding, by the penetration testing software module, that the first data packet and the second data packet are the same data packet and that the first network node is able to send data packets to the second network node, and
ii. determining, by the penetration testing software module, the method by which the attacker could compromise the networked system, wherein the method by which the attacker could compromise includes a step in which the first network node sends a third data packet to the second network node, the third data packet being used for compromising the second network node, and
e. reporting, by the penetration testing software module, the method by which the attacker could compromise the networked system, wherein the reporting comprises at least one of (i) causing a display device to display a report including information about the determined method by which the attacker could compromise the networked system, (ii) recording the report including the information about the determined method by which the attacker could compromise the networked system in a file, and (iii) electronically transmitting the report including the information about the determined method by which the attacker could compromise the networked system.

2. The method of claim 1, wherein the first data packet and the second data packet are TCP packets.

3. The method of claim 2, wherein the first data packet and the second data packet are SYN-ACK TCP packets.

4. The method of claim 2, wherein the first data packet and the second data packet are ACK TCP packets.

5. The method of claim 2, wherein the first data packet and the second data packet are SYN TCP packets.

6. The method of claim 1, wherein (i) the first information includes a first value of a given field of a header of the first data packet, (ii) the second information includes a second value of the given field of a header of the second data packet, and (iii) a necessary condition for the first information to match the second information is that the first value equals the second value.

7. The method of claim 6, wherein the given field is a field that is unchanged by network address translation (NAT).

8. The method of claim 6, wherein (i) the first data packet and the second data packet are both data packets of a type selected from a group consisting of SYN-ACK TCP packets, ACK TCP packets and SYN TCP packets, and (ii) the given field is a Sequence Number field.

9. The method of claim 6, wherein (i) the first data packet and the second data packet are both data packets of a type selected from a group consisting of SYN-ACK TCP packets, ACK TCP packets and SYN TCP packets, and (ii) the given field is an Acknowledgement Number field.

10. The method of claim 1, wherein (i) the first information includes respective first values of multiple given fields of a header of the first data packet, (ii) the second information includes respective second values of the multiple given fields of a header of the second data packet, and (iii) a necessary condition for the first information to match the second information is that for each specific field of the multiple given fields, the respective first value equals the respective second value.

11. The method of claim 10, wherein (i) the first data packet and the second data packet are both data packets of a type selected from a group consisting of SYN-ACK TCP packets, ACK TCP packets and SYN TCP packets, and (ii) the multiple given fields include a Sequence Number field and an Acknowledgement Number field.

12. The method of claim 1, wherein (i) the first information includes a first result of a first computation based on values of one or more given fields of a header of the first data packet, (ii) the second information includes a second result of a second computation based on values of the one or more given fields of a header of the second data packet, and (iii) a necessary condition for the first information to match the second information is that the first result equals the second result.

13. The method of claim 12, wherein the first computation and the second computation are both computations of a hash function.

14. The method of claim 12, wherein the first computation and the second computation are both computations of a XOR function.

15. The method of claim 12 wherein (i) the first data packet and the second data packet are both data packets of a type selected from a group consisting of SYN-ACK TCP packets, ACK TCP packets and SYN TCP packets, and (ii) the one or more given fields include a Sequence Number field and an Acknowledgement Number field.

16. The method of claim 1, wherein a necessary condition for the first information to match the second information is that the absolute value of the difference in time between the receiving of the first information and the receiving of the second information is lower than a given threshold.

17. The method of claim 1, wherein a necessary condition for the first information to match the second information is that the absolute value of the difference between a first time stamp included in the first information and a second time stamp included in the second information is lower than a given threshold.

18. The method of claim 1, wherein (i) the first information includes a first indication that indicates that the first data packet is sent by the first network node, and (ii) the second information includes a second indication that indicates that the second data packet is received by the second network node.

19. The method of claim 1, further comprising:
f. while the executing of the penetration test is ongoing, receiving, from the first network node, third information about a fourth data packet sent by the first network node;
g. while the executing of the penetration test is ongoing, receiving, from the second network node, fourth information about a fifth data packet received by the second network node;
h. further checking, by the penetration testing software module, whether the third information matches the fourth information,
wherein the concluding and the determining are carried out in response to occurrence of both (i) the determination by the checking that the first information matches the second information and (ii) a determination by the further checking that the third information matches the fourth information.

20. A system for executing a computer-implemented penetration test of a networked system so as to determine a method by which an attacker could compromise the networked system, the networked system comprising a plurality of network nodes interconnected by one or more networks, the system for executing the computer-implemented penetration test comprising:
a. a first reconnaissance-agent non-transitory computer-readable storage medium for storage of instructions for execution by one or more processors of a first network node, the first network node being in electronic communication with a remote computing device, the first reconnaissance-agent non-transitory computer-readable storage medium having stored therein first instructions, that when executed by the one or more processors of the first network node, cause the one or more processors of the first network node to send, to the remote computing device, information about a data packet sent by the first network node or received by the first network node;
b. a second reconnaissance-agent non-transitory computer-readable storage medium for storage of instructions for execution by one or more processors of a second network node, the second network node being in electronic communication with the remote computing device, the second reconnaissance-agent non-transitory computer-readable storage medium having stored therein second instructions, that when executed by the one or more processors of the second network node, cause the one or more processors of the second network node to send, to the remote computing device, information about a data packet sent by the second network node or received by the second network node;
c. a penetration-testing non-transitory computer-readable storage medium for storage of instructions for execution by one or more processors of the remote computing device, the penetration-testing non-transitory computer-readable storage medium having stored therein:
i. third instructions, that when executed by the one or more processors of the remote computing device, cause the one or more processors of the remote computing device to receive, from the first network node, first information about a first data packet sent by the first network node,
ii. fourth instructions, that when executed by the one or more processors of the remote computing device, cause the one or more processors of the remote computing device to receive, from the second network node, second information about a second data packet received by the second network node,
iii. fifth instructions, that when executed by the one or more processors of the remote computing device, cause the one or more processors of the remote computing device to check whether the first information matches the second information,
iv. sixth instructions, that when executed by the one or more processors of the remote computing device, cause the one or more processors of the remote computing device to carry out the following steps in response to a determination made by executing the fifth instructions that the first information matches the second information:
A. concluding that the first data packet and the second data packet are the same data packet and that the first network node is able to send data packets to the second network node, and
B. determining the method by which the attacker could compromise the networked system, wherein the determined method by which the attacker could compromise includes a step in which the first network node sends a third data packet to the second network node, the third data packet being used for compromising the second network node, and
v. seventh instructions, that when executed by the one or more processors of the remote computing device, cause the one or more processors of the remote computing device to report the determined method by which the attacker could compromise the networked system, wherein the reporting comprises at least one of (i) causing a display device to display a report including information about the determined method by which the attacker could compromise the networked system, (ii) recording the report including the information about the determined method by which the attacker could compromise the networked system in a file, and (iii) electronically transmitting the report including the information about the determined method by which the attacker could compromise the networked system.
